(19) United States
(12) Patent Application Publication
(10) Pub. No.: US 2026/0004307 A1
(43) Pub. Date: Jan. 1, 2026

(54) NFT SERVICE SYSTEM

(71) Applicants: HYUNDAI MOTOR COMPANY, Seoul (KR); Kia Corporation, Seoul (KR)

(72) Inventor: Minhan KIM, Hwaseong-si (KR)

(73) Assignees: HYUNDAI MOTOR COMPANY, Seoul (KR); Kia Corporation, Seoul (KR)

(21) Appl. No.: 18/955,775

(22) Filed: Nov. 21, 2024

(30) Foreign Application Priority Data
Jun. 27, 2024 (KR) 10-2024-0084779

(51) Int. Cl. G06Q 20/42; G06N 20/00; G06Q 20/36; G06T 13/40

(52) U.S. Cl. CPC G06Q 20/42; G06N 20/00; G06Q 20/3672; G06T 13/40

(57) ABSTRACT

A non-fungible token (NFT) service system is disclosed. The system includes: a vehicle configured to provide services using an owner character or a user character; a metaverse server configured to generate and manage a vehicle character for the vehicle, as well as the owner character or user character, within a metaverse environment; and a system server configured to associate the vehicle character and the owner or user character with an NFT. The NFT is based on manufacturing characteristic information of the vehicle, ensuring unique identification and enabling the preservation and transfer of vehicle-related data.

### CROSS-REFERENCE TO RELATED APPLICATION

This application claims priority to and the benefit of Korean Patent Application No. 10-2024-0084779 filed in the Korean Intellectual Property Office on Jun. 27, 2024, the entire contents of which are incorporated herein by reference.

### BACKGROUND

### (a) Technical Field

The present disclosure relates to a non-fungible token (NFT) service system for generating physical vehicle-based NFTs and providing services using these NFTs.

### (b) Description of the Related Art

Non-fungible tokens (NFTs) are virtual tokens that use blockchain technology to prove ownership of digital assets. They are used to indicate the unique originality and ownership of digital files, such as pictures and videos, by embedding the address of the digital file in the token. In other words, they are a kind of virtual certificate of authenticity. A non-fungible token is unique and similar to a national ID card that cannot be duplicated. NFTs guarantee their uniqueness by permanently recording their transactions on the blockchain.

NFTs may be applied to a wide range of technologies to provide convenience to users or provide new value.

### SUMMARY

The present disclosure attempts to provide a system that allows an owner and a user who operates a vehicle to receive various services that may be linked to the metaverse by using a non-fungible token (NFT).

An exemplary embodiment of the present disclosure provides a non-fungible token (NFT) service system comprising: a vehicle for providing a service by using an owner character or a user character; a metaverse server for providing a vehicle character for the vehicle, and the owner character or the user character in a metaverse; and a system server for associating the vehicle character, and the owner character or the user character, to NFTs based on manufacturing characteristic information of the vehicle.

The system server may receive a unique key from the vehicle, and transmit information about the owner character or the user character associated with the NFT corresponding to the unique key to the vehicle.

The metaverse server may modify and update the owner character or the user character, and transmit the changed and updated owner character or user character to the system server. The system server may update the received owner character or user character, and upon receiving a request for a recent character from the vehicle, search for an NFT corresponding to the vehicle, and transmit the updated recent character associated with the searched NFT to the vehicle.

The system server may transmit personal setting information for the vehicle, along with the recent character, to the vehicle. The vehicle may receive, download, and upload the recent character, control a relevant system within the vehicle in accordance with the personal setting information, and when there is a change in the personal setting information, transmit the change to the system server.

The system server may transmit the updated personal setting information to the metaverse server, and the metaverse server may modify the vehicle character based on the received changed personal setting information.

The vehicle may include: an input device configured to receive input in a verbal and non-verbal form from an owner or user; and an output device for externally implementing the owner character or the user character in accordance with emotion metadata corresponding to the received input. The metaverse server may include: a feedback factor database for matching and storing emotion metadata corresponding to an input received from the vehicle; and a metadata extraction processor for extracting the emotion metadata corresponding to the input received from the vehicle by using the feedback factor database. The metaverse server may send the emotion metadata to the vehicle.

The vehicle may include: an integrated control module for providing an interface by using the owner character or the user character, and recognizing and perceiving a verbal or non-verbal command provided through the interface to generate a control signal; and a command execution system for executing the command through the owner character or the user character according to the control signal, and obtaining feedback information in response to a result of the execution. The system server may include: a feedback factor database for matching and storing emotion metadata corresponding to an input received from the vehicle; and a computation system for obtaining emotion metadata from the feedback factor database based on the feedback information from the vehicle, and generating response information based on the emotion metadata. The system server may transmit the response information to the vehicle.

The command execution system may function as an AI assistant system. The AI assistant system may request recent metadata and information about a latest character for the NFT from the system server, and the system server may, in response to the request, determine the recent metadata and the recent character for the NFT based on the last log record and transmit the determined recent metadata and recent character to the vehicle.

The AI assistant system may execute an animated scenario provided from the system server by using the owner character or the user character, and execute an update for the owner character or the user character in the vehicle based on changes to the owner character or the user character in the metaverse through association with the metaverse server.

The AI assistant system may collect input data of owner behavior or user behavior, collect result data generated through a behavior corresponding to each of the input data, and perform learning based on a causal relationship between each of the input data and the corresponding result data. The AI assistant system may build a model that predicts a behavior pattern based on the input after the learning.

The AI assistant system may collect input data, preprocess it, analyze patterns using a predictive model based on the preprocessed data, predict future behavior through pattern analysis, extract behavior-related information from the prediction results, and make decisions using the extracted information. The vehicle may include an integrated control module that authenticates an owner or user associated with the NFT, controls the vehicle based on information associated with the NFT set by the authenticated owner or user and vehicle-specific information, and receives NFT-related information from the system server. The system server may generate a character for the vehicle during production of the vehicle, confirm and issue the NFT using unique information of the vehicle upon confirmation of purchase of the vehicle, associate a character generated before the purchase of the vehicle with the NFT, update and store the character associated with the NFT, and transmit the character associated with the NFT to the vehicle.

The vehicle may include an integrated control module that controls an infotainment system to provide a first meeting function when a customer who has purchased the vehicle first enters the vehicle.

The NFT service system may further include a manufacturer server of a manufacturer producing the vehicle. The metaverse server may set, during a production process for the vehicle, a vehicle character name for a vehicle character representing the vehicle being produced, and transmit the vehicle character name to the manufacturer server. The manufacturer server may link the vehicle character name to the vehicle being produced, generate a message about the vehicle production process, and transmit the message to the metaverse server.

The metaverse server may update the vehicle character by incorporating the vehicle production process message to the vehicle character.

The NFT service system may further include a payment server for receiving a payment approval request with payment information from the vehicle, and extracting user information from the payment information

The system server may receive the user information from the payment server, identify a user by searching for an NFT associated with the user information in the blockchain main net, and notify the payment server of the user specified. Upon receiving the user specifying notification, the payment server may perform confirmation and verification of the user, and approve the payment.

The vehicle may transmit an accident notification and a rescue request to the system server when a vehicle accident occurs, and the system server may recognize the vehicle accident, specify a user at the time of the occurrence of the vehicle accident, and obtain information about the user through an NFT associated with the user.

The NFT service system may further include terminals or servers of organizations authorized to update vehicle-related information. The system server may assign a vehicle item code corresponding to a change to the vehicle received from the terminals or servers. The system server may generate a vehicle item character corresponding to the vehicle item code, and transmit the vehicle item code and the vehicle item character to the metaverse server. When a change to the vehicle occurs, the metaverse server may update a character of the vehicle by reflecting a vehicle item character corresponding to the change to the character of the vehicle.

The metaverse server may notify the system server of the update of the character of the vehicle. The system server may record and store information about the update of the character of the vehicle in association with the NFT on the blockchain main net.

According to an exemplary embodiment of the present disclosure, a variety of metaverse-linked services can be provided to a vehicle owner and user through NFTs.

### BRIEF DESCRIPTION OF THE DRAWINGS

FIG. 1 is a block diagram illustrating a structure of a service system using an NFT according to exemplary embodiments.

FIG. 2 is a diagram illustrating a relationship between an NFT and a derivative NFT of a user.

FIG. 3 is a diagram illustrating a character creation process according to exemplary embodiments.

FIG. 4 is a block diagram illustrating some configurations of a system server according to exemplary embodiments.

FIG. 5 is a diagram illustrating a text-to-image conversion method according to exemplary embodiments.

FIG. 6 is a block diagram illustrating some configurations involved in determining a voice for a character in the system server according to exemplary embodiments.

FIG. 7 is a block diagram illustrating some configurations involved in determining an operation for a character in the system server according to exemplary embodiments.

FIG. 8 is a block diagram schematically illustrating an NFT market within a metaverse environment according to an exemplary embodiment.

FIG. 9 is a flowchart illustrating an example of a use of a character according to exemplary embodiments.

FIG. 10 is a diagram illustrating a method for updating a character associated with an NFT in a vehicle according to exemplary embodiments.

FIG. 11 is a diagram illustrating a configuration for extracting emotion metadata in each of a vehicle and a Metaverse server according to exemplary embodiments.

FIG. 12 is a block diagram illustrating some configurations of a vehicle. FIG. 13 is a block diagram illustrating an AI assistant system according to an exemplary embodiment.

FIG. 14 is a flowchart illustrating operations that the AI assistant system performs by executing a corresponding program according to exemplary embodiments.

FIG. 15 is a diagram illustrating a configuration of a vehicle according to exemplary embodiments.

FIG. 16 is a flowchart illustrating a method for providing a service through a character during a vehicle production process.

FIG. 17 is a flowchart illustrating a payment method involving NFTs according to exemplary embodiments.

FIG. 18 is a flowchart illustrating a method of responding to an incident of the system server according to exemplary embodiments.

FIG. 19 is a flowchart illustrating a service method for purchasing vehicle accessories in the physical world.

FIG. 20 is a flowchart illustrating a service method for purchasing vehicle items within a metaverse.

### DETAILED DESCRIPTION OF SOME EXEMPLARY EMBODIMENTS

The accompanying drawings are provided for helping to easily understand exemplary embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinal number, such as first and second, are used for describing various components, but the components are not limited by the terms. The terms are used only to discriminate one component from another component.

In the present application, it will be appreciated that terms “including” and “having” are intended to designate the existence of characteristics, numbers, operations, operations, components, and components described in the specification or a combination thereof, and do not exclude a possibility of the existence or addition of one or more other characteristics, numbers, operations, operations, components, and components, or a combination thereof in advance.

A service system according to the present disclosure may employ dynamic non-fungible tokens (NFTs). Traditional NFTs have fixed metadata assigned to them when they are first issued. In contrast, the metadata of the dynamic NFT may be changed, and the NFT may be updated. A smart contract may change the NFT based on external conditions. For example, the smart contract may change the metadata in response to a change in external conditions and change the image for the NFT based on properties of the changed metadata. In an exemplary embodiment, the external condition may be a vehicle history, driving history, owner change history, or the like, and the smart contract may change the NFT based on the change in the external condition. The updated NFT may also be applied in a metaverse environment.

A smart contract is a digital contract that exists in a software program that operates a blockchain, and the conditions necessary for the execution of the smart contract are set in the smart contract. A smart contract may be implemented as an application, and a processor that executes a smart contract application may be implemented as a combination of software and hardware. Since the software program that operates the blockchain is executed to operate a blockchain main net, the smart contract application may be executed on the blockchain main net. Hereinafter, the phrase “on a blockchain” is used to refer to at least some of the blockchains that configure a “blockchain main net” or to refer to a particular blockchain.

The blockchain main net includes a chain-link oracle, enabling all smart contracts on the blockchain to receive external data through it. External data includes off-chain data, such as data provided by an application programming interface (API) external to the blockchain. A chain link oracle may include a plurality of chain link nodes, the plurality of chain link nodes is connected together over the network, and may interface with the outside of the blockchain through an adapter. The chain link oracle may be implemented as a combination of software and hardware.

An NFT may be issued by a smart contract. The smart contract may manage the issuance of NFTs, the ownership of NFTs, the trading of NFTs on the blockchain, and the like. The smart contract may issue the NFT in the form of an identifier based on standard tokens and store the NFT as an on-chain on the blockchain. The smart contract may store metadata, media files, and the like as an off-chain outside of the blockchain.

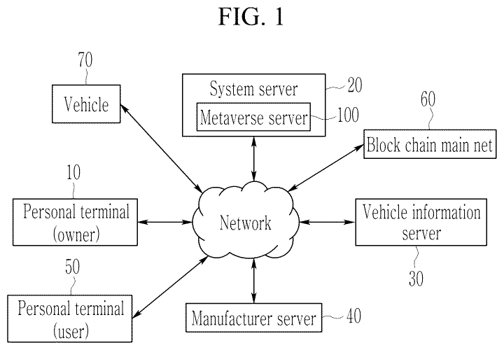

FIG. 1 is a block diagram illustrating a structure of a service system using an NFT according to some exemplary embodiments.

As shown in FIG. 1, an NFT service system 1 may include personal terminals 10 and 50, a system server 20, a vehicle information server 30, a manufacturer server 40, and a blockchain main net 60. In the NFT service system 1, the personal terminals 10 and 50, the system server 20, the vehicle information server 30, the manufacturer server 40, the blockchain main net 60, and a vehicle 70 are each connected through a network, and may transmit and receive information necessary to provide or receive services using NFTs.

The personal terminal 10 may be a device with an application installed for utilizing various NFT-based services by the vehicle owner. The personal terminal 50 may be a terminal on which an application for utilizing various services based on NFTs by a user of the vehicle has been installed. A user of the vehicle refers to a person using the vehicle 70 other than the owner of the vehicle. When necessary, the owner and the user of the vehicle may be referred to collectively as the “user side” or the owner of the vehicle and the user of the vehicle may be referred to separately. The NFT service of the present disclosure may be provided to a user side through an application executed on the personal terminals 10 and 50. The personal terminals 10 and 50 may be a PC, a smart device, or the like on the user side, or a vehicle that includes a wireless communication device and is equipped with an operating system capable of operating the application.

The manufacturer server 40, operated by the vehicle manufacturer, may transmit vehicle manufacturing characteristic information to the system server 20. Based on the commands provided by the system server 20 and the vehicle manufacturing characteristic information, the blockchain main net 60 may issue NFTs based on the vehicle manufacturing characteristic information. Alternatively, unlike the illustration of FIG. 1, the system server 20 may include a blockchain main net that issues NFTs based on the manufacturing characteristic information of the vehicle. The blockchain main net 60 may be based on a private blockchain. The smart contract on the blockchain main net 60 can be executed to issue an NFT. The NFT may be minted and issued to be associated with a vehicle unique key corresponding to the vehicle, a character matched to the NFT (NFT character), and vehicle owner and/or user information. The owner and/or user information may be stored on the associated system server 20, and the NFT character may be stored in the system server 20 as a vehicle character corresponding to the vehicle. The smart contract application may retrieve character, owner, and/or user information from the system server 20 through the chain link oracle. Minting and issuing NFTs and issuing NFTs may be understood as the same meaning.

The present disclosure does not limit the time when NFTs is issued. For example, an NFT for a corresponding vehicle may be issued at the start of the production process. When the conditions for the smart contract to be executed are satisfied at the start time of the vehicle production process, such as the owner of the vehicle is determined, unique information about the vehicle is specified, and vehicle information exists, the smart contract may issue NFTs on the blockchain from the start time of the vehicle production process. As the production process progresses, the metadata of the NFT may be updated according to new information provided by the relevant server.

In the present disclosure, an NFT serves as a means of holding value. An NFT may be generated based on a vehicle unique key, a vehicle unique code, a unique serial number, or the like, so that the NFT may demonstrate the uniqueness of the corresponding vehicle and its association with the vehicle. The NFT may be traded in conjunction with the vehicle transaction, or may be traded solely when the vehicle does not exist. Through the NFT, an owner and/or a user of a vehicle may be authenticated, and permissions to use to an NFT character associated with the NFT in the metaverse and within the vehicle may be granted.

The system server 20 may generate a vehicle character representing the vehicle 70, and may generate an owner character or user character, which is a character representing an owner or user. In the following description, the meaning of “owner character or user character” may include an owner character, a user character, and both an owner character and a user character. Additionally, descriptions of a user character apply equally to an owner character, and vice versa.

The system server 20 may associate a vehicle character with an NFT based on unique information of the vehicle. The system server 20 may associate an owner character or a user character with the NFT along with the vehicle character. The system server 20 may generate a vehicle character, an owner character, and a user character before issuing NFTs and associate the generated vehicle character, owner character, and user character with the NFTs after issuing NFTs. The system server 20 may generate a vehicle character, an owner character, and a user character after issuing NFTs and associate the generated vehicle character, owner character, and user character with the NFTs. In the following description, an NFT character may include the vehicle character, the owner character, and the user character associated with the NFT. An owner character or user character may be implemented as an owner avatar or user avatar matched to an owner or user. The system server 20 may change and update the vehicle character in response to changes in information about the vehicle and/or the user side, may generate a new user character or owner character when a user is added to the user side or the owner changes, and may change and update the user character or owner character in response to changes in the information about the user or owner. Hereinafter, a user-side character may be understood as a collective expression of a user character and an owner character.

The system server 20 may further include a metaverse server 100. A vehicle character and a user-side character provided by the system server 20 may represent the vehicle 70 and the owner or the user in a metaverse environment provided by the metaverse server 100. The vehicle and user-side characters may be used both in the vehicle and the metaverse. For example, a vehicle character may be utilized to represent a vehicle in the AVN system of the vehicle 70, an owner character, for example, an owner avatar, may be utilized to represent an owner of the vehicle, and a user character, for example, a user avatar, may be utilized to represent a user of the vehicle.

The vehicle information server 30 may be a server operated by entities involved in the characteristic change of the vehicle, for example, a server or terminal of a vehicle repair shop, a server or terminal of a vehicle parts manufacturer, a server or terminal of an industrial company that repairs and/or tunes vehicles, and a server of an insurance company that generates vehicle accident history, or may be connected through a network to collect information about the characteristic change of the vehicle from each of these servers or terminals. The vehicle information server 30 may collect the vehicle characteristic change and transmit the collected characteristic change to the system server 20. The system server 20 may update or change the NFT character by reflecting the vehicle characteristic change.

The personal terminal 50 may be a personal terminal accessed by a purchaser who has traded a vehicle and/or NFT with the user side. Transactions between personal terminals 10 and 50 may be facilitated through an application supporting vehicle and/or NFT transactions. The corresponding application may provide the transaction history to the system server 20. The system server 20 may change the NFT character and/or change the user-side character based on the transaction of the vehicle and/or NFT. For example, when a vehicle is traded, the system server 20 may generate a new owner character, such as an owner avatar, and associate the generated owner character with the NFT. Then, the owner avatar corresponding to the NFT character may be changed. However, vehicle information, history, and NFTs remain immutable as records on the blockchain. The vehicle history may include information about the vehicle's accident, the vehicle's repair, the vehicle's maintenance, the vehicle's tuning, and the like.

Vehicles are movable property with property value and by their nature, may be shared by multiple owners, have different owners and users, or have multiple users in addition to the owner. In addition, there are cases where a vehicle owned by a legal entity is operated by multiple people, such as a lease or rental. Therefore, multiple avatars may represent the user side. The plurality of avatars may be derived from and associated with NFT characters utilized in the metaverse or on the vehicle.

After issuing the NFT associated with the vehicle, the system server 20 may issue derivative NFTs for each user other than the owner of the corresponding vehicle through the blockchain main net 60. By using each of the derivative NFTs, the system server 20 may store information of each user in a block of the blockchain main net 60 and use the derivative NFT corresponding to each user for authentication of each user on the blockchain. The system server 20 may issue derivative NFTs in association with the NFTs on the blockchain main net 60. The system server 20 cannot issue standalone derivative NFTs and does not allow their independent trading. The system server 20 may verify that the user is authorized as a user of the corresponding vehicle. The system server 20 may obtain information necessary for the verification through the personal terminal 50. The system server 20 may provide transactions for NFTs based on vehicle transactions or transactions for NFTs alone, but not provide transactions for derivative NFTs alone. The system server 20 may store and manage information about the owner and the history of the owner's changes on the blockchain by using NFTs. When there is a change in information about a user in the metaverse, the system server 20 may update the changed information on the blockchain by using a derivative NFT corresponding to the user whose information has changed. User activities in the metaverse may then be recorded on the blockchain via their respective derivative NFTs. That is, the derivative NFTs may be utilized independently of the NFTs in the metaverse.

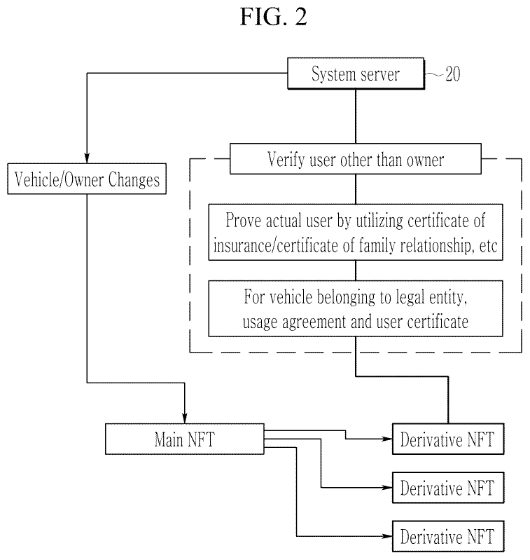

FIG. 2 is a diagram illustrating a relationship between an NFT and a derivative NFT of a user.

When changes are made to the vehicle and/or the owner, the system server 20 may store the changed information on the blockchain by using NFTs.

The system server 20 can authenticate non-owner users to issue derivative NFTs. The system server 20 may authenticate the user by comparing a vehicle insurance certificate provided through the personal terminal 10 with an insurance certificate obtained from a server of a corresponding insurance company. Alternatively, the system server 20 may authenticate the user using a certificate of family relationship between the vehicle owner and the user provided through the personal terminal 10. When the vehicle is owned by a legal entity, the system server 20 may authenticate the user by using a user certificate and a usage agreement between the legal entity and the user provided through the personal terminal 10. When the user has been authenticated, the system server 20 may issue a derivative NFT associated with the NFT for each user. For multiple users, the system server 20 may issue multiple derivative NFTs, as shown in FIG. 2. The system server 20 may record and store changes in vehicle characteristics and/or changes in a vehicle owner in the blockchain in association with the NFT, and may record and store the recorded and stored change information associated with the NFT in the blockchain even in association with a plurality of derivative NFTs in the blockchain. That is, a new record associated with the NFT is generated as a new block to constitute the block chain, and the new block for the NFT may also be associated with the derivative NFTs of the NFT.

In order to collect information about a purchaser, the following methods are commonly used: 1) a method of inducing a purchaser to enter the information directly on a website or application that is capable of collecting purchaser's information, 2) a method of collecting an email address or phone number of a purchaser, 3) a method of recognizing a purchase history of a purchaser, and 4) a method of collecting social media information of a purchaser. Data mining techniques may be used to extract metadata or meaningful information from the collected purchaser's information. Data mining is the technique of finding patterns or rules in large amounts of data, and may utilize statistical analysis, machine learning, and artificial intelligence techniques. For example, from a shopper's purchase history data, information, such as each shopper's gender, age, residential location, product type, and payment method, may be extracted, and through the extracted information, the popularity of products by gender and age group may be recognized, or the proportion of sales by payment method, and the like may be analyzed. In addition, purchasers' tastes, preferences, interests, and the like may be extracted from the social media information. The extracted data can be used to identify purchaser behavior patterns and inform product recommendation systems.

The present disclosure provides a vehicle character and an owner character or user character in the metaverse to obtain customer data. From the time the owner contracts for the vehicle, the owner unreservedly provides owner information to the system server 20 through the owner terminal to generate the vehicle character and the owner avatar which is the owner character. Because the owner actively and candidly provides the data, the manufacturer may collect highly accurate and specific owner data accumulated in the system server 20. The user may provide user information to the system server 20 through the user terminal to generate a user avatar, which is a user character, while utilizing the vehicle.

The owner may set a preferred vehicle character and/or avatar character and input text and/or prompts with metadata about the owner's characteristics directly through the personal terminal 10. The user may set a preferred avatar character and input text and/or prompts with metadata about the user's characteristics directly through the personal terminal 50. The system server 20 may extract the input owner and user characteristics and provide the extracted owner and user characteristics to the manufacturer for utilization in vehicle development. Owner and user characteristics may be stored in a database for creating vehicle and avatar characters tailored to the preferences of various owners and users. In this way, the owner and user characteristics collected through the present disclosure may be databased and accumulated, and the accumulated data may be used for product development and the creation of the vehicle character and the owner and user characters. The system server 20 may extract patterns and rules from the accumulated data, and may extract metadata representing characteristics for each of the owner and user based on the patterns and rules. The system server 20 can generate vehicle, owner, and user characters using the extracted metadata.

The system server 20 may receive information about the vehicle production process from the manufacturer server 40 and provide a view of the vehicle production process to the personal terminal 10 of the owner who will purchase the vehicle. When an owner is assigned to a vehicle, the system server 20 may receive owner information for the corresponding vehicle from the manufacturer server 40, and may generate a vehicle character and an owner character before issuing the NFT. For example, when an owner of a vehicle is identified by a vehicle purchase contract, the owner may generate a character for the owner, for example, an owner avatar, on the system server 20 through the personal terminal 10. The system server 20 may set authority to view the production process of the vehicle in the metaverse for the owner character. The system server 20 may provide information about the vehicle production process provided to the system server 20 from the manufacturer server 40 to the metaverse server 100, and the metaverse server 100 may implement the vehicle production process in the metaverse. The owner may access the metaverse as the owner character through an application installed on the personal terminal 10 or through the web. The metaverse server 100 may provide viewing of the vehicle production process in response to accessing the metaverse through the owner character. The system server 20 may grant the owner authority to create an NFT character for the vehicle upon acquisition, allowing the owner to generate the NFT character via personal terminal 10.

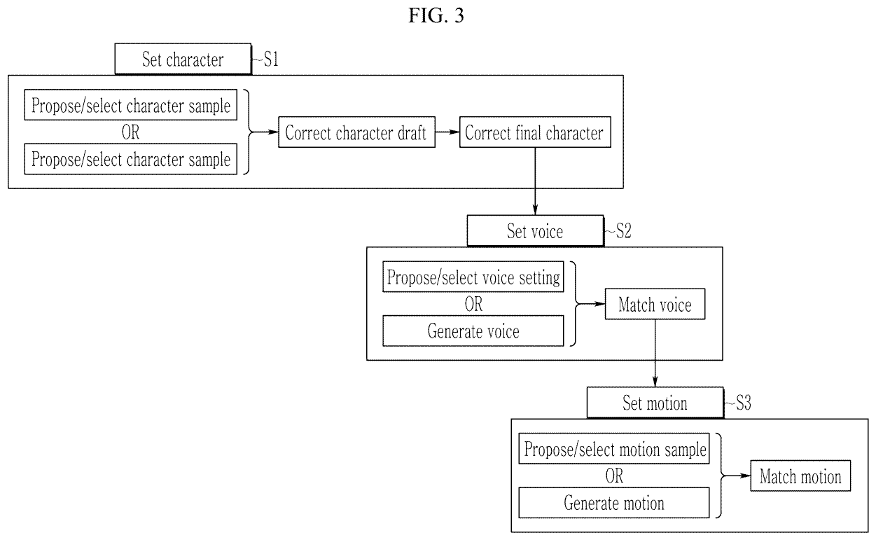

FIG. 3 is a diagram illustrating a character creation process according to some exemplary embodiments.

First, the system server 20 may set a vehicle character and an owner character (S1).

The system server 20 may present multiple vehicle and owner character samples to the owner via personal terminal 10. The system server 20 may transmit the plurality of samples of the owner character to the personal terminal 10 based on collected characteristics of the owner. For example, the system server 20 may generate a plurality of owner characters based on characteristics, such as the owner's age, gender, preferences, or personality. The system server 20 may transmit a plurality of samples of vehicle characters to the personal terminal 10 based on vehicle information and the characteristics about the owner. For example, the system server 20 may determine a default vehicle character based on the vehicle information, and may generate a plurality of vehicle character samples by tuning the default vehicle character in various ways based on the characteristics of the owner. The system server 20 may transmit the generated plurality of vehicle character samples to the personal terminal 10, and the owner may select the vehicle character samples and the owner avatar samples through the personal terminal 10. Alternatively, the owner may generate the vehicle character samples and the owner avatar samples by using an application installed on the personal terminal 10.

The owner may modify the vehicle character sample and the owner avatar sample through an application installed on the personal terminal 10. When the modifications to the vehicle character sample and the owner avatar sample are completed, a final character may be determined. The owner may transmit the completion of the modification to the system server 20 through the personal terminal 10, and the system server 20 may set the vehicle character and the owner avatar by determining the character at the time of completion of the modification as the final character.

The system server 20 may also assign voice data to the vehicle character and owner avatar (S2). The system server 20 may transmit a plurality of voice samples for each of the vehicle character and the owner avatar to the personal terminal 10. For example, the system server 20 may generate a plurality of voice samples for the owner character based on the owner characteristics and the owner avatar, and a plurality of voice samples for the vehicle character based on the vehicle information and the vehicle character. The system server 20 may transmit the generated plurality of voice samples to the personal terminal 10, and the owner may select a voice sample for each of the vehicle character and the user avatar through the personal terminal 10. Alternatively, the owner can create custom voices for the vehicle and owner characters using an application on personal terminal 10. The voice samples may include voice data that indicates the frequency components, wave shape, loudness, and the like of the voice.

The system server 20 may match the selected voice sample or the owner-generated voice sample to the owner character.

The system server 20 may also assign motion data to the vehicle and owner characters (S3). The system server 20 may transmit a plurality of motion samples for each of the vehicle character and the owner character to the personal terminal 10. For example, the system server 20 may generate multiple motion samples for the owner character based on the owner's characteristics. The system server 20 may transmit the generated plurality of motion samples to the personal terminal 10, and the owner may select at least one motion sample for the owner character through the personal terminal 10. Alternatively, the owner may generate at least one motion for each of the vehicle owner characters through an application installed on the personal terminal 10.

In the description of FIG. 3, only the owner is mentioned, but the user character may be implemented in the same way.

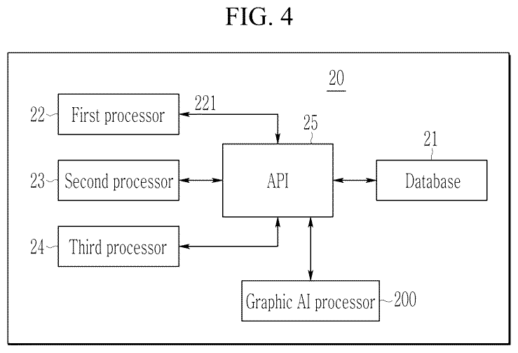

FIG. 4 is a block diagram illustrating some configurations of the system server according to some exemplary embodiments.

As shown in FIG. 4, the system server 20 may include a database 21, a first processor 22, a second processor 23, a third processor 24, a graphic artificial intelligence (AI) processor 200, and an application processor interface (API) 25. Each of the plurality of processors 22, 23, 24, and 200 may execute an installed application. The API 25 may provide interfacing between the plurality of processors 22, 23, 24, and 200, interfacing between each of the plurality of processors 22, 23, 24, and 200 and the database 21, and interfacing between the external network and the system server 20.

The database 21 may store and manage various information about each of the plurality of vehicles. For example, the various information about each of the plurality of vehicles may include the planning intent of the vehicle, information about prospective demanders, information about purchasers, preferences of the purchaser, ages, tastes, and preferences of the primary customers, and the like. Additionally, the database 21 may store information on multiple vehicle characters, owners, and user characters. The database 21 may include direct information and indirect information about each of the vehicle and the owner and/or user. The direct information may include responses to surveys, responses and the like to certain well-intentioned questions asked of prospective demanders and actual demanders in the character creation process. Indirect information may include background information about the owner and user, such as age and occupation, and information obtained by information obtaining means with unspecified purpose (purpose other than character creation). Information about purchasers and prospective demanders may be based on analysis data of the needs of actual purchasers targeted by OEMs that have not resulted in actual purchases. The vehicle's planning intent may be derived from analyzing prospective buyer data. The information to be stored in the database 21 may be represented as text and prompts with metadata, and may clarify direct or indirect information about future actual purchasing customers or users, or obtain differences from predictions.

The first processor 22 may extract text and prompts representing attributes of the character's object from the information stored in the database 21. The first processor 22 may detect, from the information stored in the database 21, information necessary to generate a vehicle character, generate text and prompts about the vehicle based on the detection contents, detect information necessary to generate an owner or user character, and generate text and prompts about the owner or the user based on the detection.

The first processor 22 may collect the text by performing morphemic analysis to remove unnecessary or irrelevant content from the sentences utilized by the owner or the user within the text collection environment. Further, the first processor 22 may collect text based on content words, such as nouns, verbs, and adjectives, while excluding non-words, such as articles, from the sentences utilized by the owner or the user. The first processor 22 may apply text mining to the collected text to identify textual patterns and trends in the unstructured data to structure the text. The first processor 22 may use text analytics on the structured text to derive quantified insights. The second processor 23 may extract metadata required for character generation (hereinafter, character metadata) from the text and the prompt. The “text” and “prompt” may be sources for obtaining character metadata necessary to form a character associated with the NFT, such as a vehicle character, an owner character, and a user character. The “text” may include contents of the characteristics of the vehicle, owner, user, and the like that are required to obtain the character metadata. The “prompt” may include inputs, questions, tasks, instructions, contexts, output types, and the like that are required during the process of obtaining character metadata through artificial intelligence.

The second processor 23 may generate character metadata represented as vector values or numerical values based on attributes inherent in each of the text and prompts. In order to build a model through machine learning or deep learning, which is an example of AI learning, the text and prompt each need to be converted into metadata as vector values or numbers that the computing device may understand. For example, the second processor 23 may map words or phrases in the text and prompts to real-number vectors through word embedding and word vectorizing. Specific implementation methods may leverage known techniques, enabling the second processor 23 to extract character metadata necessary for character generation. The graphic AI processor 200 may generate the character by using the obtained character metadata. The vehicle character, the owner character, and the user character may be collectively referred to as “characters” in the present disclosure.

The graphic AI processor 200 generates a vehicle character by using information and character metadata associated with the vehicle in the database 21, and may generate an owner character or user character by using information and character metadata matching the owner or the user in the database 21. The information associated with the vehicle in the database 21 may include vehicle images, photographs, 3D data, and the like, and the information matching the owner or the user in the database 21 may include tastes and preferences for appearance, and the like in the owner's age or the user's age range.

The graphics AI processor 200 may build an AI model by learning to image text representing character metadata (hereinafter, character text). The graphic AI processor 200 may apply various known text-to-image conversion AI models. For example, the graphics AI processor 200 may be implemented with one or a combination of two or more of a diffusion probabilistic model that incrementally adds noise to data and then learns to generate data from the noise, a latent space model that applies diffusion to image embedding instead of image pixels, and the like.

Character text may be input to the graphic AI processor 200, and the graphic AI processor 200 may image the character text to generate the character.

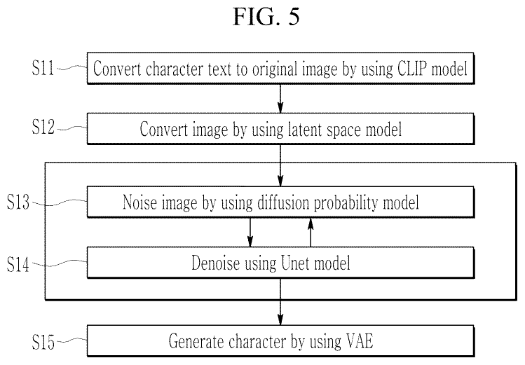

FIG. 5 is a diagram illustrating a text-to-image conversion method according to some exemplary embodiments.

The graphic AI processor 200 may encode the character text through a contrastive language-image pre-training (CLIP) model and convert the encoded character text to a certain image (hereinafter, the original image) (S11). The certain image may contain a plurality of image tokens corresponding to the character text. The CLIP model may be built by training to pair a plurality of texts in which character text is encoded with a plurality of images in which various vehicle images, photographs, and 3D data are encoded.

The graphic AI processor 200 may convert the original image implemented as pixel information through the latent space model into an image in latent space (hereinafter, the latent image) of relatively small dimension (S12).

The graphic AI processor 200 may apply noise to the latent image using a diffusion probabilistic model (S13). The graphic AI processor 200 may perform denoising on the noised latent image by using a UNet model (S14).

The graphic AI processor 200 may repeat operations S3 and S4 a plurality of times to finally generate a final image in the latent space. For example, the latent image denoised in operation S4 may be noised again through operation S3, and the noised latent image may be denoised again through operation S4. This process can be repeated either a predefined number of times or as determined by training.

The graphic AI processor 200 may apply a Variational Auto encoder (VAE) to the final image to convert the final image to pixel information to generate a character (S15).

The pixel information increases in size as the resolution increases, and resources of the processor are used exponentially to process the pixel information. In some exemplary embodiments of the present disclosure, the preceding operation of the diffusion probability model further includes an operation of encoding the text to a latent image in the latent space and an operation of decoding the latent image to pixel information, so that noising and denoising may be implemented in the latent space of much smaller dimension, not in the entire image according to pixel information. As a result, the amount of resource usage is greatly reduced even for generating images of relatively large resolution, and character generation may be executed even on a graphics card of an ordinary home.

The owner can create a vehicle and owner character via personal terminal 10 and transmit them to system server 20. The user may generate a vehicle character and a user character through the personal terminal 50 and transmit the generated vehicle character and user character to the system server 20. The third processor 24 may refine the vehicle characters and owner/user characters received from the personal terminals 10 and 50 based on the character metadata.

The system server 20 may transmit the vehicle character and the owner character generated by the second processor 23, or the vehicle character and the owner character tuned by the third processor 24, to the personal terminal 10. The system server 20 may transmit the vehicle character and the user character generated by the second processor 23, or the vehicle character and the user character tuned by the third processor 24, to the personal terminal 50.

The owner may accept the characters sent to personal terminal 10 by system server 20. Alternatively, the owner may determine the character by accepting or further modifying the tuned character provided to the personal terminal 10 by the system server 20. The user may accept the character provided to the personal terminal 50 by the system server 20. Alternatively, the user may determine the character by accepting or further modifying the tuned character provided to the personal terminal 10 by the system server 20. A finally determined character from among the character generated by the second processor 23, the character tuned by the third processor 24, and the character generated by the owner or the user and received by the system server 20 from the personal terminals 10 and 50 may be transmitted to the database 21 through the API 25.

The database 21 may store the character transmitted through the API 25 by matching the character to a corresponding target among the vehicle, the owner, and the user. The data stored in the database 21 may be used as training data for the graphic AI processor 200 to generate the character from the metadata. FIG. 1 illustrates that the characters are stored in the database 21, but a separate character database may be built. This feedback structure allows character-related data in database 21 to be updated. Thus, the graphic AI processor 200 may be provided with a circulation learning structure for generating characters and receiving feedback on the characters from owners and users.

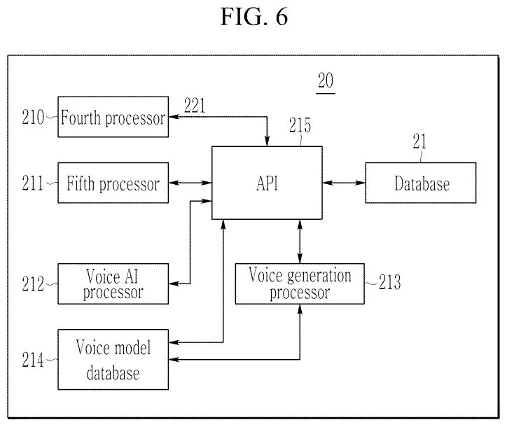

FIG. 6 is a block diagram illustrating some configurations involved in determining a voice for a character in the system server according to some exemplary embodiments.

As shown in FIG. 6, the system server 20 includes a database 21, a fourth processor 210, a fifth processor 211, a voice AI processor 212, a voice generation processor 213, a voice model database 214, and an API 215. The database 21 is configured similarly to the embodiment in FIG. 4.

Each of the fourth processor 210, the fifth processor 211, the voice AI processor 212, and the voice generation processor 213 may execute an installed application, and the API 215 may provide interfacing between the processors 210 to 213 and the database 21.

The fourth processor 210 may obtain the text and prompts required to generate voice from the database 21 in a similar manner to the first processor 22. Additionally, the fourth processor 210 may obtain the text and prompts from metadata held by the character generated for the owner or the user, the voice provided by the vehicle, biographical information, such as gender and age, for each of the owner and user, and the like. The fourth processor 210 may detect only the speaker's voice portion of the voice provided by the vehicle and extract voice characteristics from the detected voice.

The fifth processor 211 may generate voice metadata by using the text and prompts provided by the fourth processor 210 in a manner similar to the second processor 23. The fifth processor 211 may generate voice metadata, which may be represented as vector values or numerical values, based on attributes inherent in each of the text and prompts.

The voice AI processor 212 may build an AI model by learning to generate voice data based on the voice metadata obtained by the fifth processor 211, and may generate voice data from the voice metadata. Voice data may contain details such as speed, intensity, pronunciation, and intonation.

The voice model database 214 may store a plurality of factors that may be considered in generating voice data and voice data based on the plurality of factors. The various factors may include characters generated by the system server 20, words and stylistic styles used by the owner and the group to which the user belongs, and the like.

The voice AI processor 212 may perform AI training to generate voice data corresponding to the voice metadata provided from the fifth processor 211 by using the plurality of voice data stored in the voice model database 214.

In this case, applicable training methods may include statistical synthesis methods, deep learning-based synthesis methods, and others. The statistical synthesis method may be one of a hidden Markov model (HMM) based synthesis method and a pitch-synchronous overlap and add (PSOLA) based synthesis method. The HMM-based synthesis method is a method of dividing the voice signal by a regular unit, identifying the characteristics of each unit, and combining the respective units to generate a voice. The PSOLA-based synthesis method is a method of generating a new voice by utilizing existing voice components in the voice signal. Deep learning-based synthesis methods may include WaveNet and Tacotron. The WaveNet method may predict the next sampling value based on the previous sampling value of the voice signal to generate a natural sound during the voice generation process by using a deep learning model. The Tacotron method may generate a voice signal based on text of the metadata input to the deep learning model that generates voice from text.

The voice generation processor 213 may generate a voice signal by converting the voice data generated by the voice AI processor 212 into a digital signal. The voice generation processor 213 may adjust the frequency components, waveform shape, loudness, and the like of the voice data to generate a voice signal that approximates human voice. The voice generation processor 213 may select a dialogue style and words based on a character corresponding to the owner or the user. Dialogue styles and vocabulary for each character are stored in the voice model database 214. The voice generation processor 213 may generate sentences by using the dialogue style and words selected based on the character, make the generated sentence into voice, and generate a voice signal. Alternatively, the processor retrieves common words and stylistic features used by the owner's or user's group from the voice model database 214. Further, the voice generation processor 213 may obtain words and stylistic information that are commonly used by the owner or the user from the voice model database 214. Furthermore, the voice generation processor 213 may select one of the honorifics and casual speech. The voice generation processor 213 may convert the voice data into a digital signal to generate a voice signal based on the obtained dialog, words, and stylistic information, and the selected honorific or casual speech. The voice generation processor 213 may provide the generated voice signal to the API 215, and the voice signal may be transmitted to the personal terminal 10 or 50 of the owner or the user through the API 215.

When the system server 20 generates a voice signal based on the voice metadata and transmits the generated voice signal to the personal terminal 10 or 50, the owner or the user may select the received voice signal through the personal terminal 10 or 50. Alternatively, the owner or the user may modify the provided voice signal through a voice tuning application installed on the personal terminal 10 or 50 or through the web that provides a voice tuning function. Alternatively, the owner or the user may generate the voice signal by using a voice generation application installed on the personal terminal 10 or 50 or the web providing a voice generation function. When the voice signal is modified or generated, as opposed to being selected by the personal terminal 10 or 50, the owner or the user may adjust a plurality of components of the voice signal by using the voice tuning application/web, or may generate the voice signal by using the voice generation application/web while adjusting the plurality of components of the voice signal. These components may include frequency, waveform, and loudness of the voice signal.

The API 215 may receive a voice signal selected by the owner or the user through the personal terminal 10 or 50, or a voice signal generated or tuned by the owner or the user by using the personal terminal 10 or 50, through the personal terminal 10 or 50. The API 215 may transmit the received voice signal to the voice model database 214, and the voice model database 214 may match the corresponding voice signal to at least one of the owner or the user, the owner character or the user character, and a group to which the owner or the user belongs and store the matched voice signal. This feedback structure allows the voice model database 214 to update its voice signal data. Thus, the voice AI processor 212 may be provided with a circulation learning structure for generating a voice signal and receiving feedback on the voice signal from an owner and user.

The system server 20 may generate motion information for each of the vehicle character, the owner character, and the user character, and apply the generated motion information to each of the characters.

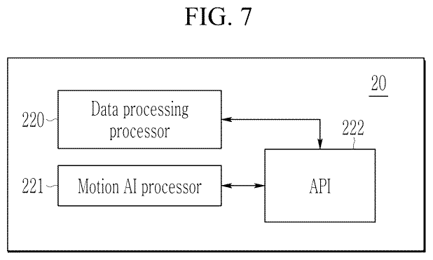

FIG. 7 is a block diagram illustrating some configurations involved in determining an operation for a character in the system server according to some exemplary embodiments.

The system server 20 comprises a data processing processor 220, a motion AI processor 221, and an API 222.

The data processing processor 220 may process image data provided through the API 222 to extract motion data of human movements or article movements that exhibit a specific motion, and may convert the extracted motion data into animations to generate animation data. The image data are various images including images of actual human motions or article movements, images generated by a video-generating AI, such as Sora, and may be provided externally to the API 222. The process by which the data processing processor 220 extracts motion data from the captured image data may be implemented with algorithms built through machine learning training. Various known machine learning techniques may be used.

The motion AI processor 221 may combine the animation data into animated motion data by using an AI algorithm and provide the animated motion data to the API 222. The AI algorithm may use various known techniques, including generative AI.

The metaverse server 100 may provide a metaverse market for providing characters, voices, motions, and the like. In addition to the characters, voices, motions, and the like, provided by the system server 20, a person authorized to access the metaverse market through the metaverse server 100 (hereinafter, referred to as a metaverse user) may directly generate scenarios with characters, voices, motions, and the like through an application installed on the terminal or the web, and upload the generated scenario to the metaverse market for sale.

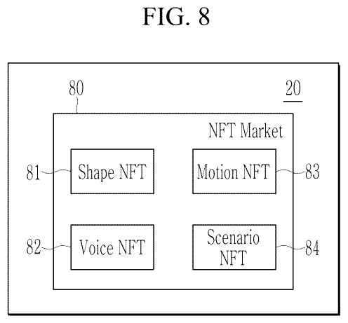

FIG. 8 is a block diagram schematically illustrating an NFT market provided in a metaverse environment according to an exemplary embodiment.

FIG. 8 illustrates an NFT market to which NFTs associated with shape, voice, motion, and scenario are uploaded, as an example of a metaverse market.

The metaverse user may generate shapes, voices, motions, and scenarios, and request the system server 20 to generate NFTs for the generated content. Upon request, system server 20 generates and associates NFTs with the provided content. The metaverse user may upload a shape NFT 81, a voice NFT 82, a motion NFT 83, and a scenario NFT 84 to the NFT market 80. In response to requests from the plurality of metaverse users, the system server 20 may provide the NFT market 80 formed of the plurality of NFTs.

The system server 20 may associate the NFT for the vehicle with the NFT purchased in the NFT market 80. The owner or the user may purchase at least one of the shape NFT 81, the voice NFT 82, the motion NFT 83, and the scenario NFT 84 from the NFT market 80 through the personal terminal 10 or 50 and request the system server 20 to associate the purchased NFT with the NFT for the vehicle. The system server 20 links the purchased NFT to the vehicle NFT upon request.

The system server 20 may sell the associated NFTs along with the NFT for the vehicle upon selling the vehicle. Through this, not only the NFT for the vehicle but also the NFT with sale value may be secured, and various metaverse users may be attracted. This may enhance engagement, making the metaverse system more active.

The form representing the NFTs may be implemented as an avatar having at least one of a character, a voice, and a motion. These avatars may be utilized in the metaverse and the vehicle. Hereinafter, the form representing the NFT utilized in the metaverse and the vehicle is referred to as an NFT avatar.

The metaverse server 100 may operate an avatar for each of the owner and the user, and the character for the vehicle within a metaverse platform. For example, as a character reflecting the owner or the user, an owner avatar or user avatar, and a vehicle character corresponding to the vehicle may be utilized within the metaverse platform. The vehicle character may differ in appearance from the actual vehicle. When there is a plurality of users utilizing the vehicle, the system server 20 may generate a user avatar for each of the plurality of users. The metaverse server 100 may assign permissions and resources to the plurality of users such that each of the plurality of users may simultaneously access and interact with the metaverse platform with the corresponding avatar.

The metaverse server 100 may apply the NFT only to the vehicle character, apply personal environment setting for each of the owner and the user only to the owner character (for example, avatar) and the user character, respectively, and store data about the personal environment settings. Applying the NFT to only the vehicle character may mean that only the vehicle character is dependent on the NFT. Information about the owner and the user is associated with the NFTs and recorded and stored on the blockchain, and the metaverse server is off-chain distinguished from the blockchain. System server 20 may allow NFT holders to access owner and user information linked to the NFTs. The NFT holder possessing the NFT may be the owner. When the owner is changed through a vehicle transaction, the original owner may block the changed owner from viewing information about the original owner or allow with limitation the changed owner to view information about the original owner.

The vehicle 70 may use a vehicle character within the vehicle. The vehicle 70 may be personified through the vehicle character, and networking may be provided between the owner or the user and the vehicle. This may enable the formation of a rapport between the vehicle and the owner or the user. Furthermore, the vehicle 70 may be perceived as having an offline presence capable of facing the owner or the user, rather than an online presence, and the vehicle character may be changed into various forms, such as holograms, as display advances. The vehicle character may also serve as a communicator in the vehicle 70, such as an AI assistant, to provide the owner or the user with various functions of the vehicle 70. When connected to a smart device, the vehicle character can extend its functionality to the device.

The system server 20 may provide character sharing between the metaverse server 100 and the vehicle 70.

Because the system server 20 generates the character in association with the NFT, the character may hold a vehicle's code and information about the owner and user of the vehicle. The vehicle code includes unique identifiers like a vehicle-specific key. The vehicle 70 may identify the person who is getting and/or traveling in the vehicle and provide services through the character corresponding to the identified person.

When a person authorized to use the vehicle 70, such as an owner or user, unlocks and gets in the vehicle 70, the vehicle 70 may recognize the owner or the user through the means by which the vehicle 70 was unlocked, and may provide services through the character for the recognized owner or user. The owner or the user may mean a person authorized to get in and operate the vehicle 70.

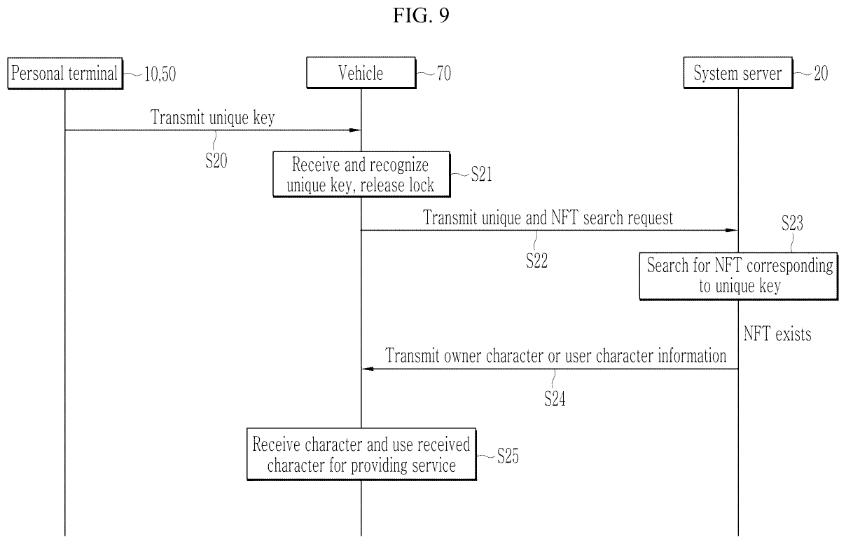

FIG. 9 is a flowchart illustrating an example of a use of a character according to some exemplary embodiments.

The owner's or user's personal terminal 10 or 50 may store a unique key indicative of authority to use the vehicle 70. The personal terminal 10 or 50 may transmit the stored unique key to the vehicle 70 (S20). The personal terminal 10 or 50 may include a communication means, such as a smartphone, and an information processing IC, such as a CPU. Information about a unique key assigned to the owner or the user may be associated with the NFT.

Vehicle 70 recognizes the unique key and unlocks (S21). The vehicle 70 may transmit the unlocked unique key to the system server 20, and may request the system server 20 to search for the NFT corresponding to the unique key (S22).

The system server 20 may search for the NFT corresponding to the unique key and determine whether the NFT exists (S23). The system server 20 may search the blockchain main net for NFTs with recorded information matching the owner or the user indicated by the unique key.

When the NFT exists, the system server 20 may transmit information about the owner character or user character associated with the NFT to the vehicle 70 (S24).

The vehicle 70 receives the character from system server 20 and uses it to provide services (S25). Alternatively, the vehicle 70 may recognize the owner or the user and release the lock of the vehicle 70 by using a vehicle monitoring device, such as an in-cabin camera (ICC), or a fingerprint recognition device. In this case, the vehicle 70 may transmit information about the recognized owner or user to the system server 20 instead of the unique key described with reference to FIG. 9. The unique key and recognized owner/user data are collectively referred to as owner-unique or user-unique information.

The system server 20 may search for NFTs based on the received owner-unique information or user-unique information, and when an NFT exists as a result of the search, the system server 20 may transmit the owner character or user character associated with the NFT to the vehicle 70.

When there is the NFT associated with the owner or the user recognized by the vehicle 70, the vehicle 70 may download a recent character from the system server 20 and upload the downloaded character to the system within the vehicle 70.

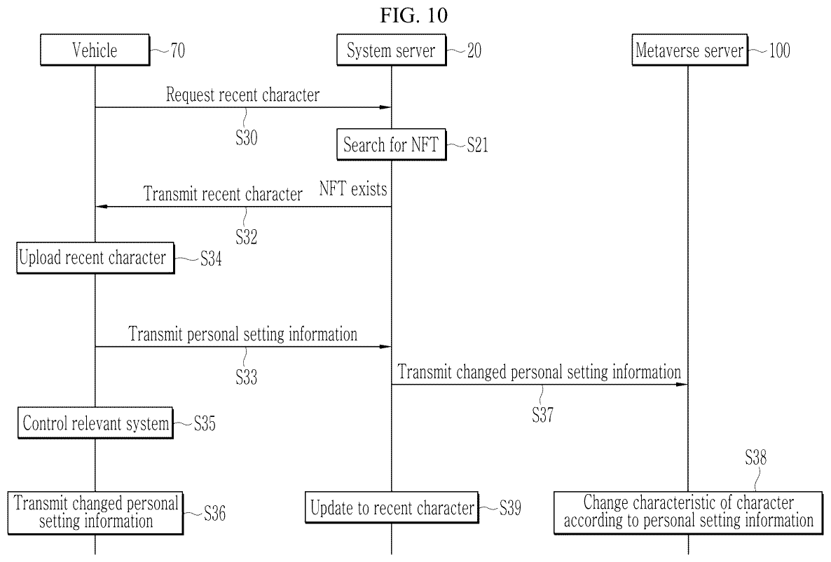

FIG. 10 shows a method for updating an NFT-associated character in a vehicle, as per exemplary embodiments. When an owner or user changes the characteristics of the character in the metaverse, the metaverse server 100 may change and update the owner character or user character to reflect the changed characteristics of the character, and may transmit the changed owner character or user character to the system server 20. The system server 20 may update the received owner character or user character with the recent character.

The vehicle 70 may transmit a request for the recent character corresponding to the vehicle, the owner or the user, or the vehicle and the owner or the user, along with the vehicle information (S30).

The system server 20 may search for NFTs based on the vehicle information (S31).

As a result of the search, when the NFT exists, the system server 20 may look up a character history associated with the NFT to determine the recent character and transmit the determined recent character to the vehicle 70 (S32). At the same time, the system server 20 may transmit other information associated with the NFT of the owner or the user, such as personal setting information for the vehicle, such as seat position and air conditioning settings, to the vehicle 70 (S33). The system server 20 may transmit the recent character to the vehicle 70 through a communication network, such as over-the-air programming (OTA) or connected car Navigation Cockpit (ccNC), upon request of the vehicle 70.

The vehicle 70 downloads the latest character and uploads it to internal systems like AVN for use (S34). The vehicle 70 may control relevant systems within the vehicle 70 based on the personal setting information (S35).

The owner or the user may change information about the personalizable system within the vehicle 70 through an interface provided by the vehicle 70. In this case, when there is the NFT associated with the owner or the user, the interface of the vehicle 70 may store the personal setting information changed by the owner or the user, and transmit the stored personal setting information to the system server 20 (S36).

System server 20 forwards the received personal settings to metaverse server 100 (S37). The metaverse server 100 may change the vehicle character in the metaverse based on the personal setting information (S38).

The metaverse server 100 may transmit the characteristics of the changed character to the system server 20, and the system server 20 may update the changed character with the recent character (S39).

The vehicle 70 may display the character of the owner or the user on a display, and may receive commands from the owner or the user through an input device. The input device may include a switch, a keyboard, a personal terminal, such as a smartphone, or the like. The vehicle 70 may perform a function in accordance with the received command. The character of the owner or the user may change facial expressions, motions, speech tone, and the like depending on the owner's or user's situation. The character's facial expression, motion, speech tone, and the like may change based on verbal characteristics, such as the owner's or user's speech tone and volume that are input and extracted in real time, emotion metadata based on direct input from the owner or the user, and emotion metadata extracted from the before/after relationship of the situation given to the owner or the user. To enable this, vehicle 70 or metaverse server 100 must extract emotion metadata from verbal and non-verbal inputs. The emotion metadata is data that may specify a character's facial expression, motion, speech tone, and the like.

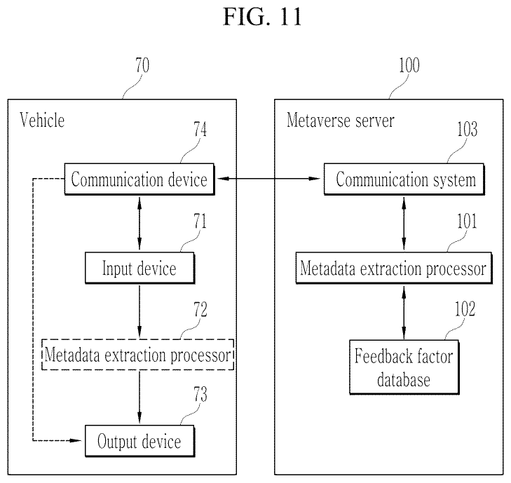

FIG. 11 shows a configuration for extracting emotion metadata in each of a vehicle and a metaverse server according to some exemplary embodiments.

The vehicle 70 may include an input device 71, a metadata extraction processor 72, an output device 73, and a communication device 74.

The input device 71 may include various kinds of devices for obtaining verbal and non-verbal forms of input from the owner or the user. Indirectly, the input device 71 may be provided with the input obtained through the personal terminal 10 or 50 or an application installed on the personal terminal 10 or 50. The input device 71 may include various interface devices within the vehicle 70, monitoring devices, such as ICCs, and the like.

The metadata extraction processor 72 may extract emotion metadata corresponding to the input provided from the input device 71 by using a feedback factor database. The feedback factor database may be a database that matches and stores emotion metadata corresponding to each of a plurality of inputs per character of an owner or user. The feedback factor database is software embedded within metadata extraction processor 72.

The output device 73 may externally implement an owner character or a user character based on the emotion metadata provided by the metadata extraction processor 72. The output device 73 may be implemented as an AVN system. The output device 73 may be implemented in a variety of ways to provide images and voices to the external, such as a display and a speakers.

The metaverse server 100 may include a metadata extraction processor 101, a feedback factor database 102, and a communication system 103.

The communication system 103 may receive input from the vehicle 70 and may transmit output corresponding to the input to the vehicle 70.

The metadata extraction processor 101 may extract emotion metadata corresponding to the input provided from the communication system 103 by using the feedback factor database 102. The feedback factor database 102 is a database that matches and stores emotion metadata corresponding to a plurality of pieces of information for each of a plurality of characters in the metaverse. This information includes inputs from vehicle 70.

The metadata extraction processor 101 may specify a character corresponding to the owner or the user, and may extract emotion metadata corresponding to the input transmitted from the vehicle 70 for the specific character from the feedback factor database 102 and provide the extracted emotion metadata to the communication system 103.

When the vehicle 70 does not include the metadata extraction processor 72, the vehicle 70 may transmit the obtained input to the metadata server 100 through the communication device 74 and request an output corresponding to the input. The metadata server 100 may receive the input through the communication system 103, obtain an output for a character corresponding to the owner or the user, and transmit the output to the vehicle 70.

The owner or the user may change the attributes of the character associated with the NFT through access through the web, an application, or the like by using the personal terminal 10 or 50, or through access by using the vehicle 70. Regardless of the type of access platform, such as an application, a web, or vehicle, the system server 20 may store the recent character information by updating change matters for the character in a final access environment. The metaverse server 100 may request the recent character information from the system server 20. The system server 20 may provide the recent character information to the metaverse server 100 in response to the request.

The vehicle 70 may provide an interface utilizing a character. Vehicle 70 uses characters as part of its AI assistant interface. An AI assistant is one example of a service provided by the vehicle 70 to an owner or user. The vehicle 70 may provide the character on a screen by using an infotainment system, such as an AVN, a cluster, a display, or an entertainment device. The vehicle 70 may recognize commands input through the character in a manner similar to voice command recognition, and perform in-vehicle functions corresponding to the recognized commands.

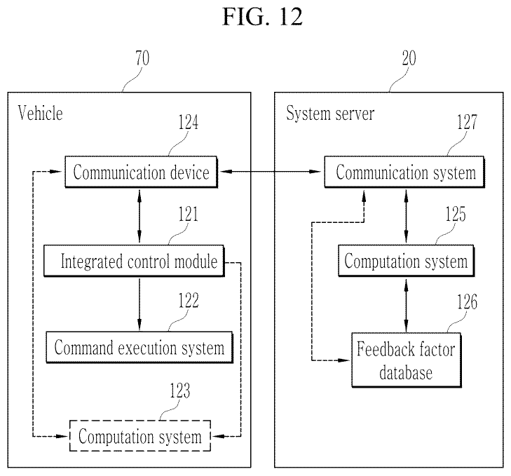

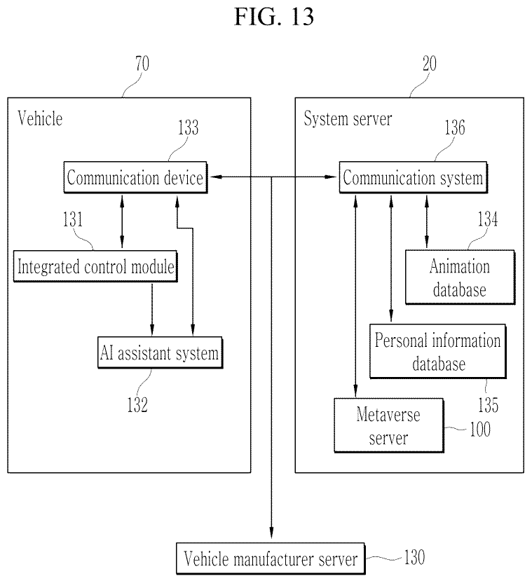

FIG. 12 is a block diagram illustrating some configurations of a vehicle.

The vehicle 70 may include an integrated control module 121, a command execution system 122, a computation system 123, and a communication device 124.

The integrated control module 121 may manage multiple devices that may provide an interface with the character, such as AVNs, clusters, displays, and entertainment devices. For example, the integrated control module 121 may be implemented to manage an infotainment system.

The command execution system 122 refers to a system that executes commands input through the owner character or the user character, such as the AI assistant. The command execution system 122 collects feedback on executed commands. The feedback information may include a reaction, response, or the like of the owner or the user to the service performed by the command execution system 122 according to the command. Feedback is one type of input vehicle 70 may receive from the owner/user.

The communication device 124 may transmit the information provided by the integrated control module 121 to an external server, or may provide the information received from the external server to the integrated control module 121.

The integrated control module 121 may provide an interface using an owner character or a user character, and may recognize and perceive verbal or non-verbal commands provided through the interface. The integrated control module 121 may specify a command execution system 122 to carry out the recognized command, and may generate and provide a control signal in accordance with the command. The command execution system 122 may execute the command through an owner character or a user character in accordance with the control signal.

The system server 20 may include a computation system 125, a feedback factor database 126, and a communication system 127.

The communication system 127 may receive feedback information obtained through the interface of the vehicle 70 from the communication device 124 of the vehicle 70 and provide the received feedback information to the computation system 125.

The computation system 125 may obtain emotion metadata from the feedback factor database 126 based on the feedback information, and may generate response information based on the emotion metadata. The feedback factor database 126 has the same configuration as described in FIG. 11. For example, the computation system 125 may extract emotion metadata, such as prompts, moods, and nuances, from the information stored in the feedback factor database 126 according to the voice information in the feedback information, and may generate visual and auditory response information, such as gestures, responses, and the like of the character, in response to the feedback information based on the extracted information.

The communication system 127 may receive the response information from the computation system 125 and transmit the received response information to the vehicle 70.

The vehicle 70 may include a separate computation system 123 that performs the same function as the computation system 125. The computation system 123 may obtain emotion metadata from the feedback factor database 126 based on the feedback information and generate response information based on the emotion metadata. In this case, the integrated control module 121 may perform a logical sum computation or a logical product computation on the response information of the computation system 123 and the response information of the computation system 125 to determine a final response.

The vehicle 70 offers an AI assistant system. As previously described in FIG. 12, one example of the command execution system may be an AI assistant system.

FIG. 13 is a block diagram of an AI assistant system according to an exemplary embodiment.

The vehicle 70 includes an integrated control module 131, an AI assistant system 132, and a communication device 133.

The integrated control module 131 relays commands to the AI assistant system 132 through an interface using owner or user characters. The AI assistant system 132 may request and obtain the recent metadata for the NFTs and information about the recent characters (for example, vehicle characters, owner characters, and user characters) from the system server 20 through the communication device 133. In response to the request from the AI assistant system 132, the system server 20 may determine the recent metadata and the recent character for the NFT based on the last log record accessed through the application, web, vehicle, or the like, and transmit the determined recent metadata and the recent character to the vehicle 70.

The system server 20 includes an animation database 134, a personal information database 135, and a communication system 136. FIG. 13 shows system server 20 with metaverse server 100, but the latter can function independently. The animation database 134 may store various animation scenarios that may be applied to a character. The personal information database 135 may store information about an individual corresponding to the character, such as an owner or user. The communication system 136 may receive information from the outside, provide the received information to the relevant configuration, and transmit the information to the outside under the control of the system server 20.

The AI assistant system 132 may be designed to provide set functions within the vehicle 70. For example, the AI assistant system 132 may be activated to be in a standby state for receiving commands from an owner or user. The AI assistant system 132 may execute a function according to the owner's or user's command. The AI assistant system 132 may receive animation scenarios stored in the animation database 134 from the system server 20 and execute the animation scenarios by using the owner character or user character. The AI assistant system 132 may execute updating for the owner character or user character on the vehicle 70 according to the changes of the owner character or user character in the metaverse through association with the metaverse server 100.

The integrated control module 131 may obtain commands for the AI assistant system 132 from the owner or the user and store the obtained commands in the personal information database 135. The AI assistant system 132 may learn a command scheme for the owner or the user by using the commands stored in the personal information database 135. After repeated learning, the AI assistant system 132 may be personalized to perform system execution within the vehicle 70 that is personalized to the owner or the user, without the need for separate commands. The vehicle manufacturer server 130 may receive various commands from the vehicle 70 and store information about the owner or the user in a separate database. The data stored in the database may be utilized for vehicle development and the like. Hereinafter, “user” collectively refers to owners and users.

In some exemplary embodiments, the vehicle 70 is equipped with physical switches, touch pads, and the like that a user may directly contact, and a microphone that may receive the user's voice. Users can issue commands to vehicle 70 via these input methods. Further, the vehicle 70 may be provided with a camera capable of acquiring non-verbal expressions, such as the user's behavior and facial expressions, and the vehicle 70 may receive commands through the camera. The vehicle 70 may generate the user's commands by analyzing the input according to the user's habit or accumulated pattern inputs. The AI assistant system 132 according to some exemplary embodiments may be a medium of interaction in obtaining the user command. For example, the AI assistant system 132 may store and execute a program implementing an algorithm that analyzes a user's behavior pattern.

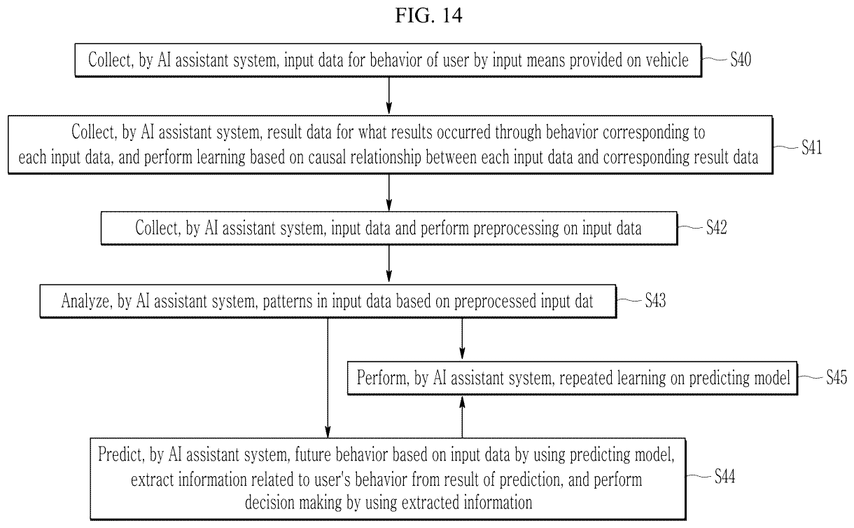

FIG. 14 is a flowchart illustrating operations that the AI assistant system performs by executing a corresponding program according to some exemplary embodiments.

The AI assistant system 132 may collect input data for behavior of the owner or the user getting in the vehicle 70 by input means provided on the vehicle 70, such as physical switches, touch pads, microphones, or cameras (S40).

The AI assistant system 132 may collect result data for what results occurred as a result of the behavior corresponding to each of the input data, and may perform learning based on a causal relationship between each of the input data and the corresponding result data (S41). Known machine learning techniques may be used for learning. After learning, the AI assistant system 132 may build a model that predicts behavior patterns based on the inputs. Various sensors may be added to the vehicle 70 for the AI assistant system 132 to collect the result data, and the vehicle 70 may collect the result data through various sensors. The vehicle 70 gathers result data via log files, online behavior logs, or user terminals. After training, the AI assistant system 132 may predict result data according to new input data.

The AI assistant system 132 may collect input data and perform preprocessing on the collected input data (S42). The AI assistant system 132 may preprocess the collected input data into a form of data that may be analyzed by a predicting model. For example, the AI assistant system 132 may remove noise of the data, handle outliers, normalize, reduce dimensions, and the like.

Based on the preprocessed input data, the AI assistant system 132 may analyze patterns in the input data by using a predicting model (S43). The input data may include behavior or voice commands.

The AI assistant system 132 may predict future behavior based on the input data based on pattern analysis using the predicting model, extract information related to the owner's or user's behavior from a result of the prediction, and perform decision making by using the extracted information (S44). Decision-making involves determining the appropriate response to user input.

The AI assistant system 132 may perform repeated learning on the predicting model built in operation S41 through operation S43 and operation S44 (S45). This may improve the accuracy of that predicting model. The AI assistant system 132 may evaluate the predicting model based on the accuracy of the predicting model after the repeated learning.

The program including operations S40 to S45 may be associated with user information in the form of a blockchain and stored on the blockchain main net, and the authority to view the corresponding information may be restricted through the NFT. In a transaction of the NFTs associated with the vehicle 70, the user selling the NFTs may determine the level of the authority to view allowed to the user purchasing the NFTs, and provide information about the level of the authority to view to the system server 20. The system server 20 may store the level of the authority to view for the user purchasing the NFT in association with the NFT, and may grant the authority to view to the user purchasing the NFT.

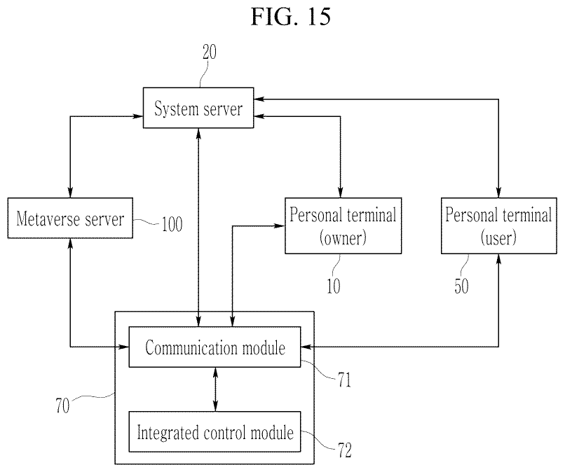

The vehicle in FIG. 15 operates per user specifications identified via NFTs. The vehicle illustrated in FIG. 15 may be controlled in accordance with user specifications recognized through NFTs. The vehicle 70 may include a communication module 71 and an integrated control module 72. The vehicle 70 may communicate with the system server 20, the user terminals 10 and 50, the metaverse server 100, and the like through the communication module 71.

The communication module 71 may provide information associated with the NFTs received from the outside, information about the characters, and the like to the integrated control module 121. The integrated control module 121 may control various configurations of the vehicle 70 by using the information provided from the communication module 71, or may process the information provided from the various configurations and provide the processed information to the communication module 71. When necessary, the communication module 71 may transmit information from the integrated control module 121 to the outside.

The integrated control module 72 may authenticate the owner or the user associated with the NFT through the NFT and control various configurations of the vehicle 70 by using the information associated with the NFT set by the authenticated owner or user (hereinafter collectively referred to as the authenticated user) through the communication module 71. In addition, the integrated control module 72 may control various configurations of the vehicle 70 by using information associated with the NFT and information set by the authorized user directly on the vehicle 70. Hereafter, “information set by the authorized user” includes both NFT data and user-configured vehicle settings.

The integrated control module 72 may store information about the authorized user's driving pose, seat position, steering wheel position, and the like in an integrated memory system (IMS), and may adjust the seat, steering wheel, and the like based on the information. The integrated control module 72 may control the heating, ventilating, and air conditioning (HVAC) system based on the air conditioning mode, such as temperature, wind direction, and air volume set by the authorized user. The integrated control module 72 may control the relevant electronic control units (ECUs) according to the drive mode set by the authorized user. The integrated control module 72 may control the cluster with the cluster layout and design set by the authorized user. The integrated control module 72 may adjust a navigation device to guide the authorized user for the destinations and routes set by the authorized user in accordance with the navigation settings (sound and volume). The integration control module 72 may control the integrated messaging system in a manner set by the authorized user. The integrated control module 72 adjusts lighting, like mood lamps, based on the authorized user's preferences. The integrated control module 72 may load and provide characters on an infotainment, such as AVN, set by the authorized user, and may control a command transmission method, a communication method, and a communication method for the characters on the infotainment according to the user settings. The integrated control module 72 may perform user authentication and unique key authentication based on the authenticated user's settings to provide financial services, high pass, and emergency call (E-call). The integrated control module 72 may control access to and startup of the vehicle 70 through the user authentication and the unique key authentication, and may manage user's personal information. The integrated control module 72 may grant authority to a first responder to view the user's personal information (blood type, address, and location information) in the event of an emergency.

Thus, the user associated with the NFT in vehicle 70 can be identified, and relevant user information utilized. For example, the integrated control module 72 may authenticate through the NFT that the person getting in the vehicle 70 is the owner or the user associated with the NFT. The integrated control module 72 may control various functions of the vehicle 70 based on information about the authorized user. The vehicle 70's IMS stores various user-preferred settings. The IMS may store many personalization elements, such as the user's seating pose, lighting brightness, mood lamp color, steering wheel position, AVN settings information, such as layout and font, volume, navigation list, favorites list, main menu window configuration, and air conditioning.

The integrated management module 72 may receive personal setting information for the authorized user from the system server 20 and store the received personal setting information in the IMS upon completion of NFT authentication of the owner or the user. In a situation where the user is acquiring a new vehicle for the first time, the integrated management module of the new vehicle may receive personal setting information from the system server 20 and store the received personal setting information in the IMS. Alternatively, when the user gets in a vehicle that is not his or her own, such as a rental car or a car-sharing vehicle, the integrated management module of the corresponding vehicle may receive personal setting information from the system server 20 and store the received personal setting information in the IMS. The integrated management module controls the vehicle based on IMS-stored information.

The user may update the final environment information to the system server 20 through the personal terminal 10 and 50, such as a smart device, the vehicle 70, the metaverse, or the like. From the personal terminals 10 and 50, the vehicle 70, the metaverse, and the like, the user authentication key and the vehicle unique key associated with the NFT may be transmitted to the system server 20 along with the final environment information. The system server 20 may associate the NFT corresponding to the received user authentication key and vehicle unique key with the final environment information and update the NFT. The system server 20 includes a database storing NFT-related information. The final environment information may include recent information about the individual user, recent information about the vehicle, recent information about the metaverse, and the like. The system server 20 may change the user character and/or change the vehicle character based on the final environment information.

In the present disclosure, the character may also be utilized to view the production process in the metaverse environment. For this purpose, system server 20 can create a character for vehicles in production before purchase. The system server 20 may associate the character generated before the vehicle is purchased with the vehicle after the vehicle is purchased. For example, the system server 20 may confirm and issue an NFT by using the vehicle unique information, such as a vehicle unique key, vehicle unique code, vehicle serial number, and the like, when confirming a vehicle purchase, and associate the character generated before the vehicle purchase with the NFT.

To facilitate a personalized interaction when a new customer greets the vehicle, system server 20 updates and stores the NFT-linked character. The system server 20 may transmit the character to the vehicle, and the vehicle may update and store the character received in the infotainment system, such as AVN. At the moment when a customer who has purchased a vehicle directly enters the vehicle for the first time, the vehicle may activate and provide a predetermined function (hereinafter referred to as a “first meeting function”) to welcome the vehicle purchasing customer. The new owner authenticates their first ride to the vehicle via their personal terminal. The vehicle may activate and provide the first meeting function when the vehicle authenticates that it is the first ride of the vehicle purchasing customer and not a ride of a dealer or vehicle inspector. The vehicle purchasing customer may authenticate the vehicle purchasing customer's first ride to the vehicle upon picking up the vehicle after confirming the vehicle purchase through the personal terminal 10 or 50.

Upon activation of the “first meeting function”, the integrated control module of the vehicle 70 may control the infotainment system to provide various performances/ceremonies. For example, the infotainment system may flash the headlamps and room lamps, play welcome music and a welcome greeting voice, run an animation including a pre-generated character for the purchaser, and provide an introduction of the vehicle. With the owner identified, the infotainment system delivers a personalized greeting tailored to them. The system server 20 may derive information about the specified owner from a customer information database, generate various scenarios for the first meeting function, and transmit the generated scenarios to the vehicle 70 for execution by the vehicle 70 in accordance with the generated scenarios. The integrated control module 121 may control the infotainment system in accordance with the received scenarios, and the infotainment system may provide the first meeting function in accordance with the control. The manufacturer server 40 (see FIG. 1) or the metaverse server 100 may update the scenarios generated by the system server 20. The manufacturer server 40 may update the scenario based on information about the purchaser (or owner) obtained during the vehicle production process. In the metaverse, the purchaser (or owner) acts through the character, the metaverse server 100 collects the information generated by the character, and may update the scenario based on the collected information. The manufacturer server 40 may recognize that the vehicle is being delivered to the purchaser and notify the metaverse server 100 and the personal terminal of the purchaser (or the owner) of the recognized fact. The purchaser (or owner) may transmit an acceptance confirmation to the metaverse server 100 and/or the manufacturer server 40 through the personal terminal, and the metaverse server 100 may transmit an acceptance confirmation to the manufacturer server 40. Scenarios are customized based on acquisition timing, purchaser characteristics, preferences, location, and more.

The vehicle may be characterized from the time a vehicle is produced to the time the vehicle is picked up and the vehicle personification work to give a vehicle character the ability to talk may progress. When the purchaser picks up the vehicle, they may feel like meeting a familiar friend. This generates a kind of rapport between the purchaser and the vehicle, so that the purchaser may have a sense of attachment and anticipation for the vehicle. It may enhance the purchaser's trust and loyalty to the company and its products. Various methods may be applied.

Vehicle characters may be linked with the vehicle's infotainment elements. When the vehicle is given a name during the vehicle production process, the vehicle's voice-recognition calling function may be associated with the vehicle name. The user may activate the calling function by calling the vehicle name. When the owner or the user of the vehicle changes, the vehicle name may also be changed.

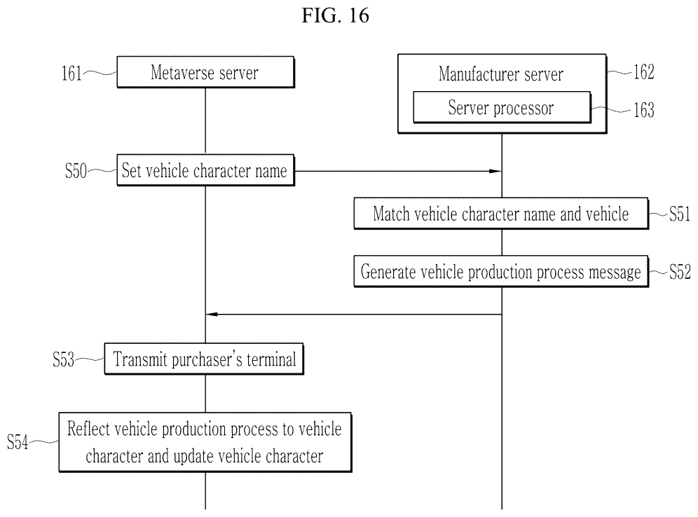

FIG. 16 is a flowchart illustrating a method of providing a service through a character during a vehicle production process.

The purchaser may set a name for a vehicle character that represents a vehicle in production in the metaverse. The metaverse server 161 then sets a name for the vehicle character (hereinafter, the vehicle character name) (S50). The metaverse server 161 transmits the vehicle character name to the manufacturer server 162.

The manufacturer server 162 may include a server processor 163. The server processor 163 is equipped with a program that contains multiple instructions for controlling and managing the operation of the manufacturer server 162. In the following description, the manufacturer server 162 can perform each step using the server processor 163.

The manufacturer server 162 may match the vehicle character name to the vehicle in production (S51). The manufacturer server 162 may generate a message about the vehicle production process (S52). The manufacturer server 162 may generate a message that includes a description of the vehicle production process for each unit production process. For example, the manufacturer server 162 may generate a message with a human-like style, “We're putting on headlamps. Now you may see better at night.”

The manufacturer server 162 may transmit the vehicle production process message to the metaverse server 161.

The metaverse server 161 forwards the production messages to the purchaser terminal (S53). The metaverse server 161 may update the vehicle character by reflecting the vehicle production process message to the vehicle character (S54). For example, the metaverse server 161 may add headlamps to the vehicle character.

Information about the vehicle owner, user, and the like may be associated with the NFT and recorded on the blockchain, and the NFT may provide a decentralized means of identity proof for the vehicle owner, user, and the like. Owners, users, and the like may use vehicle payment services, such as CAR PAY, by using the NFTs. For vehicles with multiple users, each user can have their own payment information. User information may be shared with the manufacturer server, the metaverse server, the payment server, and the like. The currently used car pay system requires a separate verification process, such as fingerprinting, to identify each user. In some exemplary embodiments, user information about each user may be associated with the NFT, and the information about each user generated during driving may be associated with the NFT and recorded in the blockchain. In other words, the information required for identifying the user performing the payment is associated with the NFT and accumulated in the blockchain. In cases of credit issues (e.g., non-payment), NFTs with property value may be seized, or vehicle operations for the user may be restricted. Further, in collecting and foreclosing on taxes owed on a vehicle upon the sale of the vehicle, the property value of the NFT may be used to settle the taxes owed, providing relief to the vehicle owner.

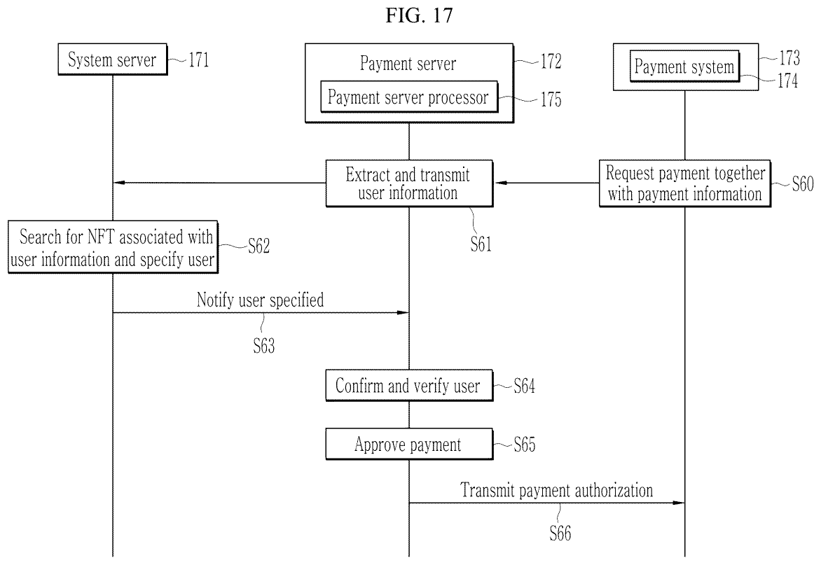

FIG. 17 shows a flowchart illustrating a payment method using the NFT according to some exemplary embodiments.

Through the payment system 174 of the vehicle 173, a user may request payment approval from the payment server 172 with payment information (S60). The payment information may include payment amount, payment method, user information, and the like. Since the user getting in the vehicle 173 is specified by the vehicle 173, the payment system 174 may receive information about the user making the payment from the vehicle 173. The vehicle 173 may transmit a payment request to the payment server 172 with the payment information. The payment server 172 may include a payment server processor 175. The payment server processor 175 is equipped with a program that contains multiple instructions for controlling and managing the operation of the payment server 172. In the following description, the payment server 172 can perform each step using the payment server processor 175.

The payment server 172 extracts user data from the payment details and forwards it to the system server 171 (S61). The system server 171 may search for NFTs associated with the user information in the blockchain main net and specify the user (S62). When the system server 171 fails to search for the NFT associated with the user information, the payment operation may end.

The system server 171 may transmit a user-specific notification to the payment server 172 indicating that the user has been specified by using the NFT (S63).

Upon receiving the user-specific notification, the payment server 172 may perform confirmation and verification of the user based on the user specifying notification (S64).

The payment server 172 may process a charge based on the payment amount and payment method, and may approve the payment (S65).

In some exemplary embodiments, the system server may specify a driver by using NFTs in the event of an accident.

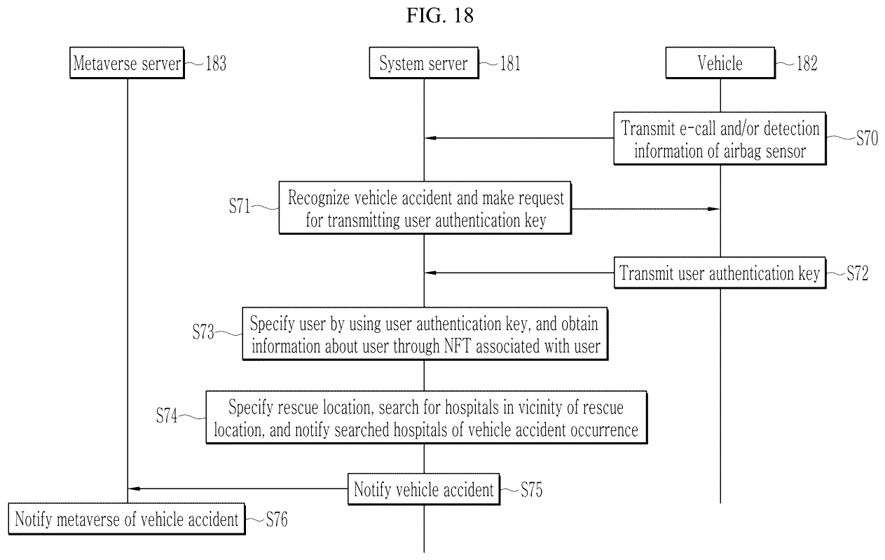

FIG. 18 is a flowchart illustrating a method of responding to an incident of the system server according to some exemplary embodiments.

In the event of a vehicle accident, the vehicle 182 may activate an e-call function to transmit an accident notification and a rescue request to the system server 181. In the event of a vehicle accident, the airbags provided in the vehicle may be activated, and the airbag sensor may detect the operation of the airbag. The vehicle 182 may transmit the detection information of the airbag sensor to the system server 181. That is, the vehicle 182 may transmit the e-call and/or the detection information of the airbag sensor to the system server 181 in the event of the accident (S70).

The system server 181 may receive the e-call and/or the detection information of the airbag sensor from the vehicle 182, recognize the vehicle accident based on the received e-call and/or detection information of the airbag sensor, and make a request for transmitting a user authentication key to the vehicle 182 (S71). When a user enters vehicle 182, it authenticates their access using the user authentication key. Thus, the vehicle 182 has information about the user authentication key for the currently occupied user.

The vehicle 182 may transmit the user authentication key to the system server 181 (S72).

The system server 181 may receive the user authentication key, specify the user by using the user authentication key, and obtain information about the user through the NFT associated with the user (S73). The information about the user may be associated with the NFT and recorded on the blockchain. For example, user information may include emergency contacts, blood type, name, medical conditions, hospital records, etc. The system server 181 may specify a rescue location based on the location of the vehicle accident, search for hospitals in the vicinity of the rescue location, and notify the searched hospitals of the vehicle accident occurrence (S74). The system server 181 may provide information about the user to the hospital along with the accident notification.

The system server 181 may notify the metaverse server 100 of the vehicle accident (S75).

The metaverse server 183 alerts the metaverse about the vehicle accident (S76). In the event that a vehicle accident occurs and the occupant is unconscious, rescue of the occupant is urgent, and obtaining information about the occupant, such as any medical conditions the occupant may be suffering from, is very critical. In some exemplary embodiments, the accident notification and information about the user provided may minimize the loss of life in a vehicle accident.

Manufacturers/sellers of vehicles may sell accessories, such as dress-up items, vehicle components, and the like (hereinafter referred to as car accessories). When an owner or user purchases a certain car accessory in the real world, the car accessory purchase may be updated on the vehicle character in the metaverse. Conversely, when an item is purchased for a vehicle character in the metaverse, a discount may be applied to the purchase of the actual car accessory corresponding to the purchased item. Car accessories may include electrical and physical devices that may be installed or mounted on a vehicle, as well as software that may improve the vehicle function.

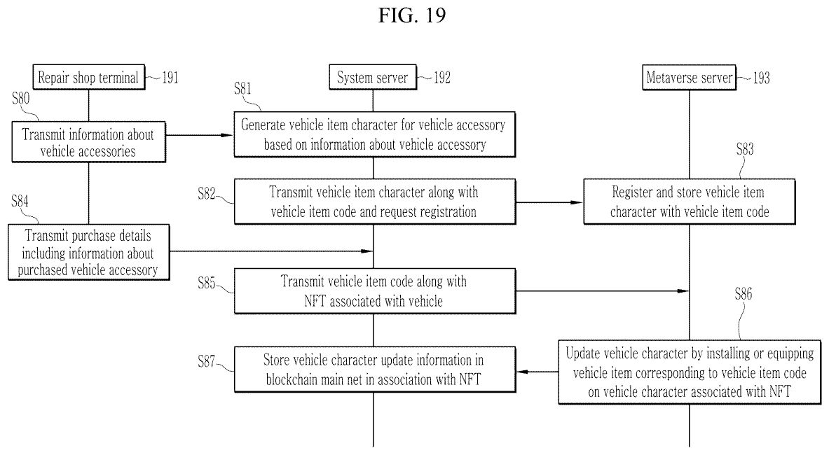

FIG. 19 shows a flowchart illustrating a service method for purchasing vehicle accessories in the real world.

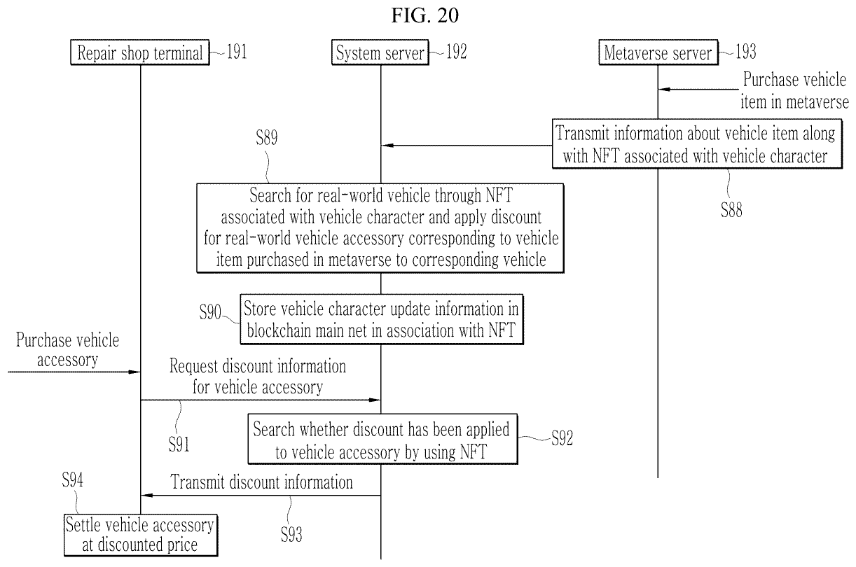

FIG. 20 shows a flowchart illustrating a service method for purchasing vehicle items in a metaverse.

A repair shop terminal 191 shown in FIGS. 19 and 20 may be provided at a real-world repair shop that sells and installs vehicle accessories. The repair shop may perform maintenance and after-sales service on vehicles, as well as sell and install vehicle accessories. Instead of the repair shop terminal, a server provided at the repair shop side, or a server or terminal of a vehicle component company, or a server or terminal of an industrial company that repairs and/or tunes vehicles, may perform the operations provided by the repair shop terminal 191. These terminals/servers belong to organizations authorized to modify vehicle information.

First, the repair shop terminal 191 may transmit information about vehicle accessories that may be provided to the system server 192 (S80).

The system server 192 may generate a vehicle item character for the vehicle accessory based on the information about the vehicle accessory. The method of generating the character for the vehicle accessory may be in accordance with operation S1 of FIG. 3 (S81).

The system server 192 may assign a vehicle item code to the vehicle accessory, and may transmit the vehicle item character along with the vehicle item code to the metaverse server 193 and request registration (S82).

The metaverse server 193 registers and stores the vehicle item character and its code (S81). When an owner or user purchases a vehicle accessory at a repair shop, the repair shop terminal 191 may transmit purchase details including information about the purchased vehicle accessory to the system server 192 (S84).

The system server 192 may receive the vehicle accessory purchase details from the repair shop terminal 191, determine a vehicle item code indicating the purchased vehicle accessory, and transmit the determined vehicle item code to the metaverse server 193 along with the NFT associated with the vehicle (S85).

The metaverse server 193 may receive the NFT and the vehicle item code, and update the vehicle character by installing or equipping the vehicle item corresponding to the vehicle item code on the vehicle character associated with the NFT (S86).

When the metaverse server 193 updates the vehicle character, the metaverse server 193 may notify the system server 192 of the update of the vehicle character. The system server 192 may record and store the vehicle character update information in the blockchain main net in association with the NFT (S87).

The owner or the user may purchase a vehicle item for the vehicle character in the metaverse. The metaverse vehicle items may correspond to real-world vehicle accessories. In this case, the metaverse server 193 transmits information about the vehicle item along with the NFT associated with the vehicle character to the system server 192 (S88).

The system server 192 may search for a real-world vehicle through the NFT associated with the vehicle character and apply a discount for the real-world vehicle accessory corresponding to the vehicle item purchased in the metaverse to the corresponding vehicle (S89). In other words, if the owner or user buys the real-world accessory, system server 20 offers a discount.

The system server 192 may record and store the vehicle character update information in the metaverse in the blockchain main net in association with the NFT (S90).

When an actual purchase of the vehicle accessory occurs, the repair shop terminal 191 may request discount information for the purchased vehicle accessory from the system server 192 (S91). At this time, the repair shop terminal 191 may transmit unique information about the vehicle to the system server 192 along with the request for the discount information.

Using the NFT corresponding to the unique information about the vehicle, the system server 192 may search whether a discount has been applied to the vehicle accessory purchased for the corresponding vehicle (S92).

The system server 192 may transmit discount information when a discount is applied to the vehicle accessory as a result of the determination in operation S92 (S93).

The repair shop terminal 191 may settle the vehicle accessory at a discounted price according to the received discount information (S94).

In addition to purchasing vehicle accessories, when changes occur to a vehicle, such as a vehicle accident, component exchange, or recall, the changes may be reflected, recorded, and stored on the blockchain in association with the NFT. Authorized entities (e.g., manufacturers, insurers, or tuning companies) can send vehicle updates to the system server 192 via their terminals or servers.

The system server 192 may set a vehicle item code corresponding to the changes to the vehicle, and generate a vehicle item character corresponding to the vehicle item code.

The system server 192 may transmit the vehicle item character along with the vehicle item code to the metaverse server 193. When a change to the vehicle occurs, the metaverse server 193 may update the vehicle character by reflecting a vehicle item character corresponding to the change to the vehicle character. For the changes to the vehicle, the metaverse server 100 may transmit update information to the system server 20, and the system server 20 may record and store the update information in the blockchain main net in association with the NFT.

In this way, when various changes to the vehicle occur, the change record may be reflected on the metaverse through the system server, and recorded and stored in association with the NFT on the blockchain. The owner or the user authorized through the NFT may view the records stored on the blockchain. Only entities authorized to change information may record changes to the vehicle through the system servers, which may improve the reliability of vehicle records. Furthermore, as the vehicle character associated with the NFT reflects changes to the vehicle, the value of the corresponding character may also change.

Characters associated with NFTs according to the exemplary embodiments of the present disclosure may be applied to services using NFTs in a variety of ways. For example, the user character may be implemented in a vehicle, such as singing along to music playing in the vehicle or singing a song himself/herself. The user character may also be applied to read news directly in the vehicle, read directions from a navigation system, or replace directions from a navigation system. The user characters can act as communication partners or interactive search bar replacements. When the user character is a three-dimensional character implemented with holographic technology, the user character may perform AI assistant functions in areas other than the vehicle, such as in the home or at work.

In the exemplary embodiment of the present disclosure, it is possible to preserve vehicle information during and after vehicle production, and issue NFTs based on vehicle information to give uniqueness to the vehicle information. To ensure that the NFTs have monetary value, in the exemplary embodiment, vehicle characters may be associated with the NFTs in the metaverse environment. The NFT may be included in a transaction target upon actual trading of the vehicle. Even for the same type of vehicle, there may be differences in production times, specifications, colors, operators, work environments, options, and the like of the vehicle, which may be considered unique characteristics for the vehicle.

In the exemplary embodiment of the present disclosure, it is possible to generate a vehicle character, an owner character, and a user character on a metaverse platform by setting each of the vehicle character, the owner character, and the user character as a unit medium and associating the vehicle character, the owner character, and the user character with NFTs. Each character gains unique value by linking to the vehicle's specific data, such as its serial or chassis number. Unlike the creation and training of virtual characters in PC games and the like, the characters provided by the exemplary embodiment of the present disclosure reflect the history that has occurred in the real world, and thus may have relevance to the real economy.

According to the exemplary embodiments of the present disclosure, a vehicle character that has uniqueness in the metaverse is provided based on the uniqueness of the actual mass-produced vehicle, so that the vehicle character may also have uniqueness. When vehicle's unique characteristics change in the real world, such as a change in color or structure, the vehicle character in the metaverse is also changed. In particular, changes, such as vehicle maintenance and accident history, tuning elements, and the like may be reflected in the vehicle character, so that the irreversible history of the vehicle is reflected in the vehicle character, thereby preserving the uniqueness that may be associated with the NFT.

The scarcity value assigned to a vehicle by an owner and an operation history of the vehicle and the like may be judged according to the determination reference of the market. For example, when the vehicle is driven by a famous celebrity, the actual ownership, duration, and operation history of the vehicle may be quantitatively value-judged. Vehicles produced in limited quantities inherently carry scarcity value. The scarcity value of the actual vehicle is reflected in the vehicle character, and the vehicle character is also subject to value assignment, so that the vehicle character may have a connection to reality.

Further, NFTs may guarantee changes to a vehicle when the vehicle is traded. That is, the NFT is traded along with the object of the transaction when value is transferred, such as when trading a used car, and even when the owner is not the original owner, the owner may view the production process of the vehicle associated with the NFT and the history of the vehicle after production through the NFT. In addition, the NFT for the vehicle may remain even when the vehicle is scrapped, so the history of a specific vehicle may be preserved forever. In addition, in some limited cases, NFTs and physical vehicles may be traded separately. For example, even when a real-world vehicle is destroyed, the character of the vehicle in the metaverse may still have value because the vehicle character is associated with the NFT.

NFTs provide manufacturers with crucial data for vehicle development. For example, by analyzing the vehicle histories associated with NFTs of multiple vehicles, a manufacturer may discover that components delivered at a certain time of day are causing problems, or that components from a certain vendor are causing problems. The manufacturer may record these findings and take action to receive improved components parts based on the recorded findings.

According to the exemplary embodiment of the present disclosure, the creation and history storage of NFTs based on the blockchain may prevent tampering with vehicle history. Transparency of vehicle transactions may be ensured, and unique scarcity value may be generated and retained for vehicles and NFTs. Even when a vehicle is lost or discontinued, the unique value of the vehicle as an NFT is preserved and may be traded separately on the metaverse. The record of the corresponding vehicle is preserved by being associated with to the NFT, and the value of the vehicle may be preserved through trading. NFTs, tied to a vehicle's unique traits, gain higher value if the vehicle type holds special significance.

Although an exemplary embodiment of the present disclosure has been described in detail, the scope of the present disclosure is not limited by the exemplary embodiment. Any modifications or changes based on the core concept, as defined in the claims, are within the scope of this disclosure.

### DESCRIPTION OF SYMBOLS

10, 50: Personal terminal
20: System server
30: Vehicle information server
40: Manufacturer server
60: Blockchain main net
100: Metaverse server

What is claimed is:

1. A non-fungible token (NFT) service system comprising:
a vehicle configured to provide a service, using a processor, by using an owner character or a user character;
a metaverse server, using a metadata extraction processor, configured to provide a vehicle character for the vehicle, and the owner character or the user character in a metaverse; and
a system server, using a plurality of processors, configured to associate the vehicle character, and the owner character or the user character, to an NFT which is based on manufacturing characteristic information of the vehicle.

2. The NFT service system of claim 1, wherein:
the system server receives a unique key from the vehicle, and transmits information about the owner character or the user character associated with the NFT corresponding to the unique key to the vehicle using at least one of the processors.

3. The NFT service system of claim 2, wherein:
the metaverse server, using the metadata extraction processor, changes and updates the owner character or the user character, and transmits the changed and updated owner character or user character to the system server, and
the system server is configured to:
update a received owner character or a user character, and
upon receiving a request for a recent character from the vehicle, search for an NFT corresponding to the vehicle, and
transmit an updated recent character associated with the searched NFT to the vehicle.

4. The NFT service system of claim 3, wherein:
the system server transmits personal setting information for the vehicle, together with the recent character, to the vehicle, and
the vehicle using at least one of the processors, receives, downloads, and uploads the recent character, controls a relevant system within the vehicle in accordance with the personal setting information, and when there is a change in the personal setting information, transmits the change to the system server.

5. The NFT service system of claim 4, wherein:
the system server transmits the changed personal setting information to the metaverse server, and
the metaverse server changes the vehicle character based on the received changed personal setting information using at least one of the processors.

6. The NFT service system of claim 1, wherein:
the vehicle includes:
an input device configured to obtain input in a verbal and non-verbal form from an owner or user; and
an output device configured to externally implement the owner character or the user character in accordance with emotion metadata corresponding to the obtained input using the processor,
the metaverse server includes:
a feedback factor database configured to match and store emotion metadata corresponding to the input obtained from the vehicle; and
the metadata extraction processor configured to extract the emotion metadata corresponding to the input obtained from the vehicle by using the feedback factor database, and
the metaverse server transmits the emotion metadata to the vehicle.

7. The NFT service system of claim 1, wherein:
the vehicle includes:
an integrated control module configured to provide an interface by using the owner character or the user character, and identify and perceive a verbal or non-verbal command provided through the interface to generate a control signal; and
a command execution system configured to execute the command through the owner character or the user character according to the control signal, and obtain feedback information in response to a result of the execution, and
the system server includes:
a feedback factor database configured to match and store emotion metadata corresponding to an input obtained from the vehicle; and
a computation system configured to obtain emotion metadata from the feedback factor database based on the feedback information from the vehicle, and generate response information based on the emotion metadata, and
the system server transmits the response information to the vehicle using the processor.

8. The NFT service system of claim 7, wherein:
the command execution system is an AI assistant system, and
the AI assistant system is configured to request recent metadata and information about a recent character for the NFT from the system server, and
the system server, in response to the request, is configured to determine the recent metadata and the recent character for the NFT based on the last log record and transmit the determined recent metadata and recent character to the vehicle using at least one of the processors.

9. The NFT service system of claim 8, wherein,
the AI assistant system is configured to:
execute an animated scenario provided from the system server by using the owner character or the user character, and
execute an update for the owner character or the user character in the vehicle based on changes to the owner character or the user character in the metaverse through association with the metaverse server.

10. The NFT service system of claim 7, wherein
the command execution system is an AI assistant system, and
the AI assistant system is configured to:
collect input data of owner behavior or user behavior,
collect result data generated through a behavior corresponding to each of the input data, and perform learning based on a causal relationship between each of the input data and the result data, and
build a model that predicts a behavior pattern based on the input after the learning.

11. The NFT service system of claim 10, wherein
the AI assistant system is configured to:
collect the input data and performs preprocessing on the input data,
analyze patterns of the input data by using a predicting model based on the preprocessed input data;
predict a future behavior based on the input data and the pattern analysis;
extracts behavior-related information from a result of the prediction; and
make decisions by using the extracted information.

12. The NFT service system of claim 1, wherein:
the vehicle includes an integrated control module that authenticates an owner or user associated with the NFT through the NFT and controls the vehicle based on information associated with the NFT set by the authenticated owner or user and information set directly by the vehicle, and
receives the information associated with the NFT from the system server.

13. The NFT service system of claim 1, wherein:
the system server using at least one of the processors, is configured to:
generate a character for the vehicle during production of the vehicle,
confirm and issue the NFT using unique information of the vehicle upon confirmation of purchase of the vehicle,
associate a character generated before the purchase of the vehicle with the NFT,
updates and stores the character associated with the NFT, and
transmit the character associated with the NFT to the vehicle.

14. The NFT service system of claim 13, wherein:
the vehicle includes an integrated control module that controls an infotainment system to provide a first meeting function when a customer who has purchased the vehicle first enters the vehicle.

15. The NFT service system of claim 1, further comprising:
a manufacturer server, using a server processor, of a manufacturer producing the vehicle,
wherein the metaverse server sets, during a production process for the vehicle, a vehicle character name for a vehicle character representing the vehicle being produced, and transmits the vehicle character name to the manufacturer server, and
the manufacturer server matches the vehicle character name to the vehicle being produced, generates a message about the vehicle production process, and transmits the message to the metaverse server.

16. The NFT service system of claim 15, wherein:
the metaverse server updates the vehicle character by reflecting the vehicle production process message to the vehicle character.

17. The NFT service system of claim 1, further comprising:
a payment server, using a payment server processor, configured to receive a payment approval request with payment information from the vehicle, and extract user information from the payment information,
wherein:
the system server is configured to receive the user information from the payment server, specify a user by searching for an NFT associated with the user information in the blockchain main net, and notify the payment server of the user specified, and
upon receiving the user specifying notification, the payment server is configured to perform confirmation and verification of the user, and approve the payment.

18. The NFT service system of claim 1, wherein:
the vehicle, using the processor, transmits an accident notification and a rescue request to the system server when a vehicle accident occurs, and
the system server recognizes the vehicle accident, specifies a user at the time of the occurrence of the vehicle accident, and obtains information about the user through an NFT associated with the user, using at least one of the processors.

19. The NFT service system of claim 1, further comprising:
terminals or servers of organizations authorized to change information related to the vehicle,
wherein the system server, using at least one of the processors, is configured to set a vehicle item code corresponding to a change to the vehicle received from the terminals or servers, generate a vehicle item character corresponding to the vehicle item code, and transmit the vehicle item code and the vehicle item character to the metaverse server, and
when a change to the vehicle occurs, the metaverse server, using the metadata extraction processor, is configured to update a character of the vehicle by reflecting a vehicle item character corresponding to the change to the character of the vehicle.

20. The NFT service system of claim 19, wherein:
the metaverse server, using the metadata extraction processor, is configured to notify the system server of the update of the character of the vehicle, and
the system server, using at least one of the processors, is configured to record and store information about the update of the character of the vehicle in association with the NFT in the blockchain main net.
